(19) United States
(12) Patent Application Publication
(10) Pub. No.: US 2019/0138165 A1
(43) Pub. Date: May 9, 2019

(54) WEB PARTS INTEGRATION IN SOCIAL NETWORKING SYSTEM

(71) Applicant: Satya Santosh Siddhantam, Columbus, OH (US)

(72) Inventor: Satya Santosh Siddhantam, Columbus, OH (US)

(21) Appl. No.: 15/944,150

(22) Filed: Apr. 3, 2018

Related U.S. Application Data
(60) Provisional application No. 62/583,920, filed on Nov. 9, 2017.

(51) Int. Cl. G06F 3/0482; G06Q 50/00; G06F 17/30; G06F 3/0484; H04L 29/06

(52) U.S. Cl. CPC G06F 3/0482; G06Q 50/01; H04L 65/608; G06F 3/0484; G06F 17/30905

(57) ABSTRACT

Disclosed is a Social Networking System. The Social Networking System includes a server capable of running a computer program product. The computer program product includes a plurality of functional modules. The functional modules include a Web Parts module configured to enable the use of Web Parts on a Graphical User Interface (GUI) for a particular user logged into their Social Networking Account. The computer program product also includes an arrangement module configured to enable the adding, removing, placing, and moving of Web Parts on the GUI. The computer program product further includes a view module configured to enable saving different views for a user, the different views including different arrangements and different collections of Web Parts. Further still, the computer program product includes a digital assistant module configured to enable voice interfacing with the Social Networking System and allowing for voice interfacing to the various Web Parts on screen.

### CROSS REFERENCE TO PRIORITY APPLICATIONS

This application claims priority to U.S. Provisional Patent Application No. 62/583,920, filed on Nov. 9, 2017 and is herein incorporated by reference in its entirety.

### BACKGROUND

The invention generally relates to a social networking system or social networking site. Social networking sites have become very integral in people's lives and accessing them in a customized and efficient manner for each user may be an important factor for a particular user to continue to use the social networking site on a very regular basis. Thus, it is desirable to provide customization and optimization to a social networking system interface or to a social networking site.

Web Parts also known as widgets, gadgets have been on websites in conventional use. The website Web Parts allow a user to design home pages by adding, removing, moving/dragging widgets/gadgets across a home page but they lack the social networking context. Another drawback in the existing Social Networking Systems/Websites is most often they use fixed design of the web pages or any objects within the social networking system with limited or no ability to change the design of the pages on the Social Networking Site.

### SUMMARY

An exemplary embodiment of the invention is directed to a Social Networking System. The Social Networking System includes a server capable of running a computer program product. The computer program product includes a plurality of functional modules. The functional modules include a Web Parts module configured to enable the use of Web Parts on a Graphical User Interface (GUI) for a particular user logged into their Social Networking Account. The computer program product also includes an arrangement module configured to enable the adding, removing, placing, and moving of Web Parts on the GUI. The computer program product further includes a view module configured to enable saving different views for a user, the different views including different arrangements and different collections of Web Parts. Further still, the computer program product includes a digital assistant module configured to enable voice interfacing with the Social Networking System and allowing for voice interfacing to the various Web Parts on screen.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1-4 are exemplary depictions of moving a Web Part on a Social Networking Graphical User Interface (GUI).

FIGS. 5-8 are exemplary depictions of Searching and adding a Web Part on a Social Networking GUI.

FIGS. 9-11 are exemplary depictions of Removing of Web Parts from a Social Networking GUI.

FIGS. 12-22 are exemplary depictions of using Web Parts views on a Social Networking GUI.

FIGS. 23-27 are exemplary depictions of switching and overlaying Web Parts on a Social Networking GUI.

FIGS. 28 and 29 are exemplary depictions of a digital assistant on a Social Networking GUI.

FIGS. 28 and 29 are exemplary depictions of a digital assistant on a Social Networking GUI.

FIG. 30 is an exemplary depiction of a construct for sharing Web Parts on a Social Networking GUI.

FIGS. 31-35 are exemplary depictions of a mobile app relating to the Social Networking System.

FIGS. 36-41 are exemplary depictions of a story boarding on a Social Networking GUI.

FIGS. 42-45 are exemplary depictions of Sidebar Menu Selection visibility.

FIGS. 46-48 are exemplary depictions of Adjustable Sidebar Menus.

FIG. 49 is an exemplary depiction of a Recent Posts functionality.

FIGS. 50-56 are exemplary depictions of Enabling Auto-post for Events.

FIGS. 57-61 are exemplary depictions of Autosuggest Emojis functionality.

FIGS. 62-67 are exemplary depictions of Share Current Status functionality.

FIG. 68 is an exemplary depiction of the Social Networking Data Handling Block Diagram.

FIG. 69 is am exemplary depiction of a Social Graph Data Storage Module.

FIGS. 70-79 are exemplary depictions of RSS Feeds in Social Networking.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

### Web Parts Integration in Social Networking System

Social networking sites are often accessed by a user through a web browser or through a web app. These browsers or apps may use Web Parts as part of the user interface. A Web Part in social networking system is any movable or portable object that can be an independent entity such as a movable chat window or something which can hold reference to other objects. A Web Part may also be a movable sidebar or movable menu bar, which can include information of objects within or outside the social networking system i.e. a movable RSS feed holder or a movable frame, gadget, or widget.

By integrating Web Parts with the Social Networking Site, Users will be able to change the design of their pages and other objects on the Social Networking Site as they need, objects include—menus, tabs, sidebar, etc. Users may also add Web/RSS feeds to their pages, create different views out of the user designed pages and share these Web Parts/web feeds with others.

An Object in a Social Networking System may contain information about a User or any other Objects. The User information, in this context, may be the data shared by the User (such as feeds shared by the User with others on the Home Page) and the Object Information refers to Video, Picture or Text Data Shared or Created by the Users. The Web Part Object that contains this User or Object Information has an interface on the page and can be moved across the page and placed (if there is enough space) in different regions of the page of user's choice and it can also be shared on social networking with other users.

In some exemplary embodiments, there may be a Web Part Manager Storage that holds all of the information relating to the Web Parts, for example, where the Web Parts are located, how they appear, and how users interact with them. In accordance with an exemplary embodiment, users will be able to design the home and any other pages in their profile within the context of the social networking site, as they want, by adding Web Parts, moving Web Parts, keeping the existing Web Parts, that they want on the page and removing the ones that they don't need.

### Third Party Web Parts:

In accordance with an exemplary embodiment, third party Web Parts can be added to the social networking system by means of a Web Parts Application Programming Interface (API). A Web Parts API may include an XML or JSON file that defines the Web Part. Syntax may be based on Web Part XML Specifications, e.g. A Web Part directory may contain all the available Web Parts developed by Developers.

Web Parts generally may be applications developed using HTML, CSS, XML JavaScript/jQuery/AngularJS, Ajax, Flash or Silverlight for dynamic behaviors which can be embedded in web pages of the social networking system and web pages of even other sites.

A Web Part Container generally may contain the xml/j son file which contains the code for the Web Part written in XML or HTML/CSS that defines the structure of the Web Part, JavaScript/jQuery/AngularJS functions for the behavior of the Web Part and/or can include any other libraries developed using javaScript/jQuery/AngularJS, Ajax, Flash, Silverlight any similar programming languages to support the Web Part functions.

### Publishing a Web Part

In accordance with an exemplary embodiment, a Web Part may be publicly available online in order for it to be accessed within a social networking site. For example, all or some of the source files of the Web Part may be hosted on any reliable web host like github.com to host XML source of the Web Parts.

In one example the correct mime type for text files, images and videos which may be used:

text/css

text/javascript

image/jpeg

In accordance with an exemplary embodiment, Web Parts may be submitted to the Web Part directory.

The resultant design is desired to be compelling, polished, user-friendly with a design that conforms to the guidelines given in policy. Also, a User may also include all of the metadata fields and ensure that all javascript, images and other URL used in the Web Part are publicly accessible.

### Web Parts Policy

In accordance with an exemplary embodiment it is desirable to enforce a Web Parts policy in a social networking context. According to an exemplay policy, what is not accepted may be:
Illegal content
Pornography or obscenity
Content that interferes with the functioning of the homepage
Promotions of hate or incitement of violence
Violations of copyright/trademark
Impersonations of third parties
Invasions of personal privacy
You may not collect or store any personal or sensitive information such as credit card numbers and social security numbers through a Web Part.
The Web Part can be Submitted to the Web Parts Directory of the Social Networking System where it will be tested for functioning, checked if it follows the guidelines mentioned in the policy and spam.
title: This title is displayed in the Web part title bar.
title_url: URL that the Web Part title links to.
category: Directory category to list Web Part. (lifestyle, tools, etc)
description: Describes the Web Part.
author: Author of the Web Part.
author_email: The Web Part author's email address.
screenshot: URL of a Web Part screenshot, should be 280 pixels wide.
thumbnail: URL of a Web Part thumbnail, should be 120×60 pixels.
height: Web Part height.
width: Web Part width.

### Moving Web Parts on the Social Networking Page:

In accordance with an exemplary embodiment, to move a Web Part, a user may select the Web Part at the top of a Web Part window and drag and place it anywhere on the page in the social networking system where there is a space available.

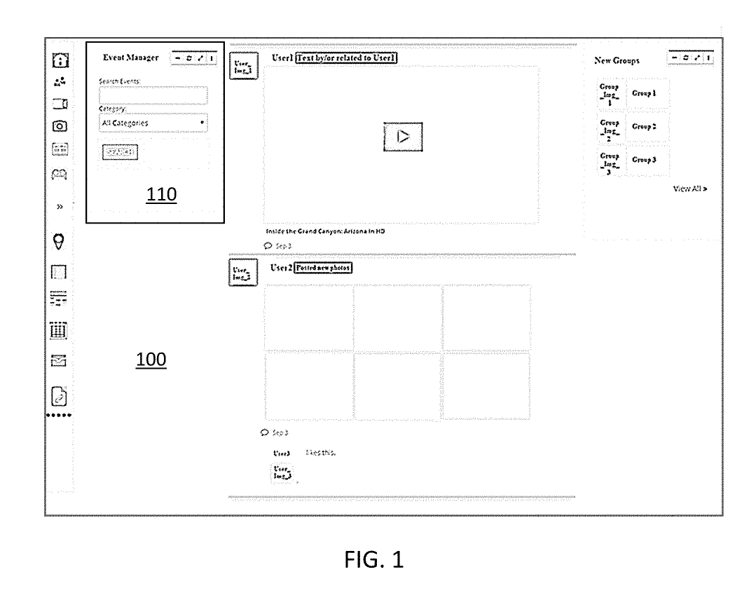

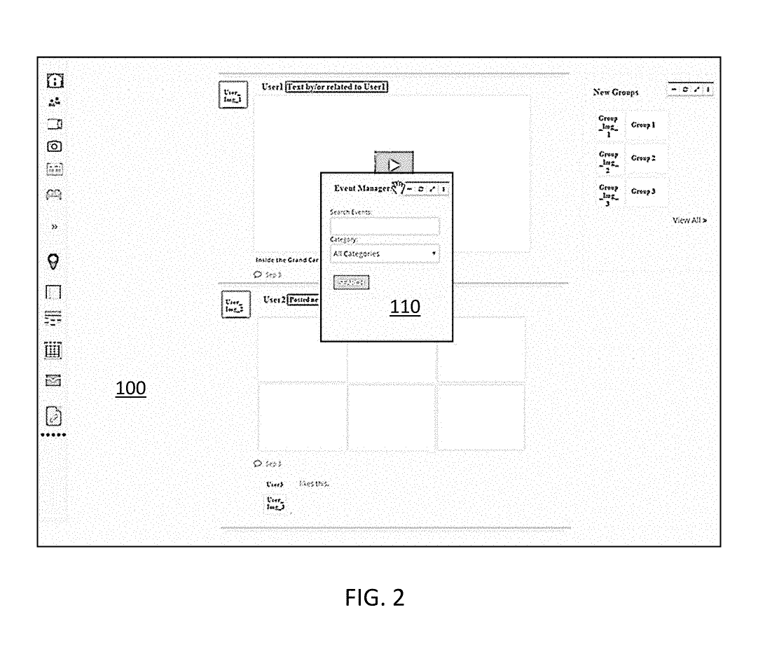

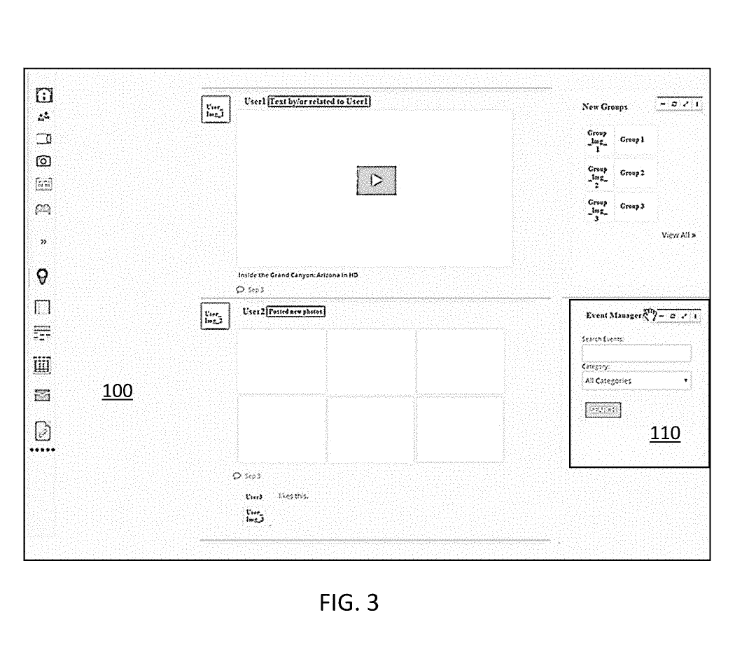

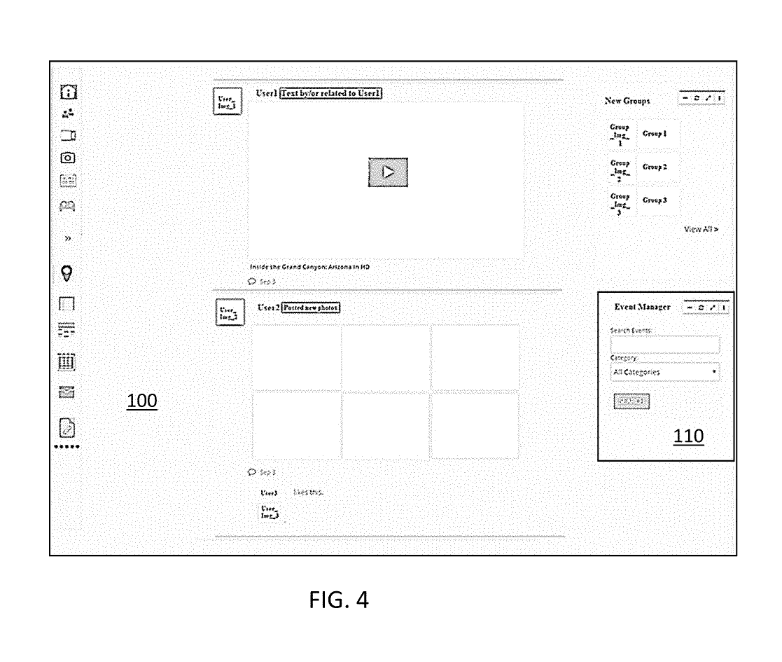

Referring now to FIGS. 1-4, an example of a Web Parts move is depicted. FIGS. 1-4 depict a graphical user interface (GUI) 100 of a computerized display. GUI 100 is a GUI for a Social Networking System or Social Networking Site. In this example Event Manager box 110 is depicted being moved from the top left of the page to the lower right portion of the page below the New Groups Web Part. This type of Web Part move facilitates social networking users to configure their site in such a way as to increase their efficiency or enjoyment.

### Adding and Restoring Web Parts

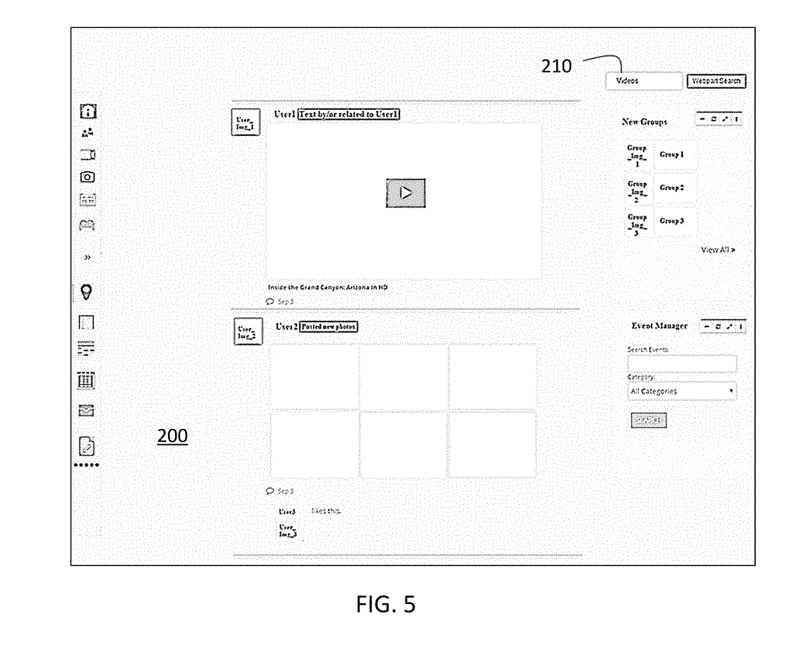

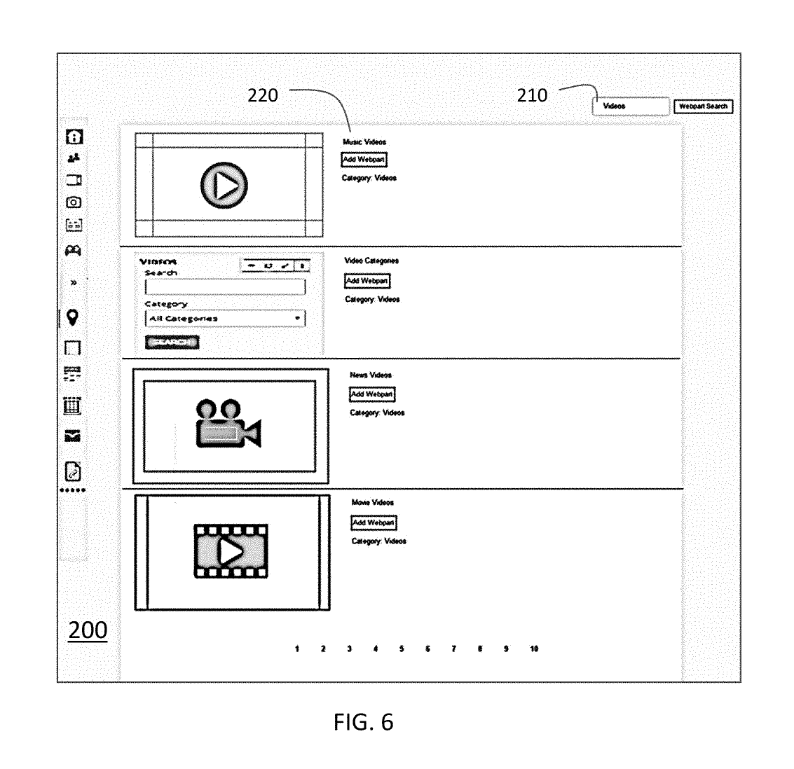

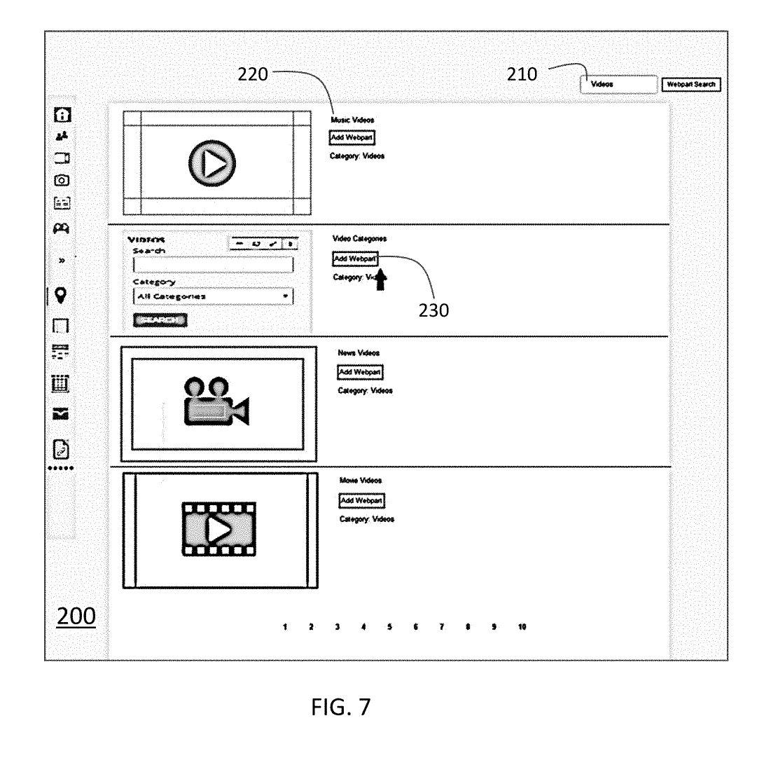

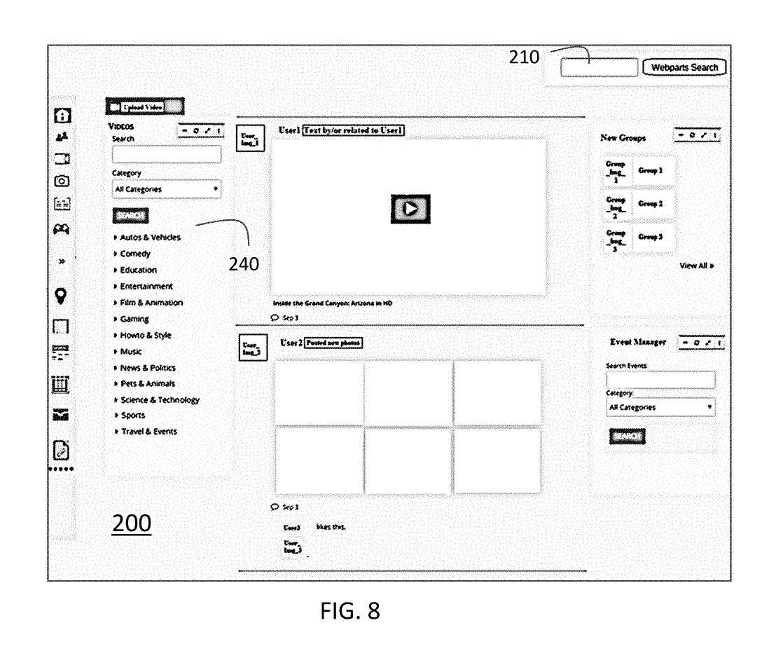

In another exemplary embodiment, Users may optionally add a new Web Part or restore a deleted Web Part. New or deleted Web Parts may be searched in a Web Part search box which may be accessed through a menu or search box on the social networking site as shown depicted in FIGS. 5-8. As an example, FIG. 5 depicts a GUI 200 with a search being done in a Web Parts search box 210. Within Web Parts search box 210, a Videos Web Part is being searched, as an example, in Search Box 210. FIG. 6 depicts GUI 200 which is shown displaying a search results page 220 containing Videos Web Part results returned after the video search. FIG. 7 depicts an action of selecting the Web Part of interest using an Add Web Part button 230 from results page 220. FIG. 8 depicts GUI 200 showing the Videos Web Part 240 having been added to the page in the Social Networking System on the left side of the page. This feature of adding and restoring Web Parts to the Social Networking GUI provides users with substantial flexibility to customize their social networking experience and optimize their use of the social network.

### Removing Web Parts:

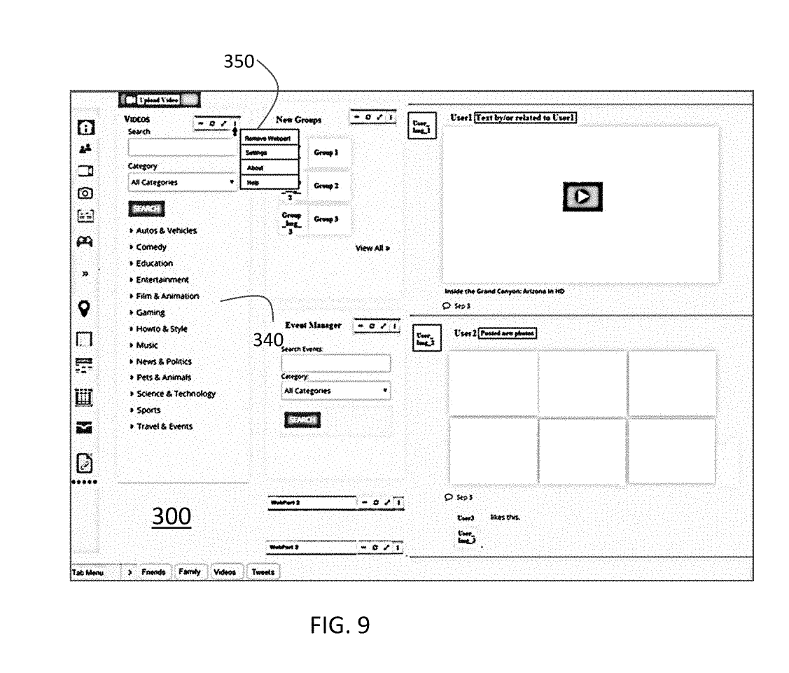

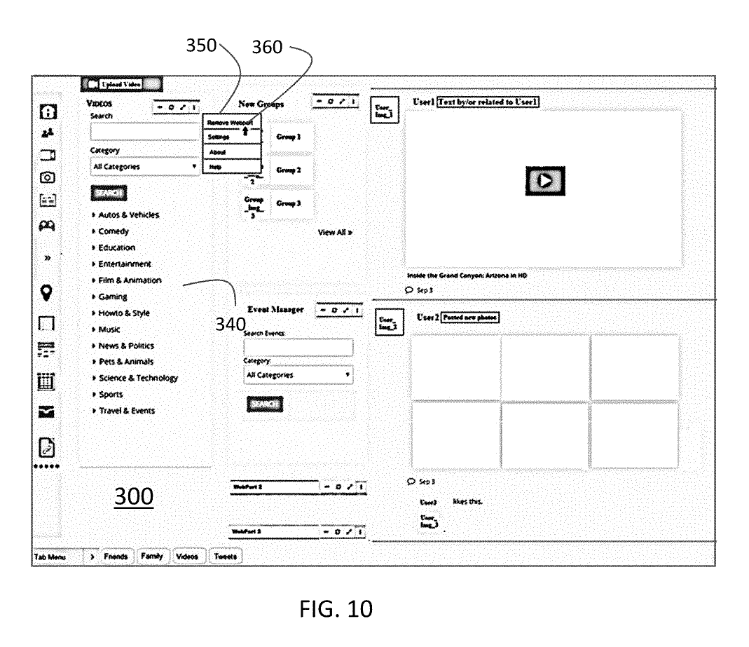

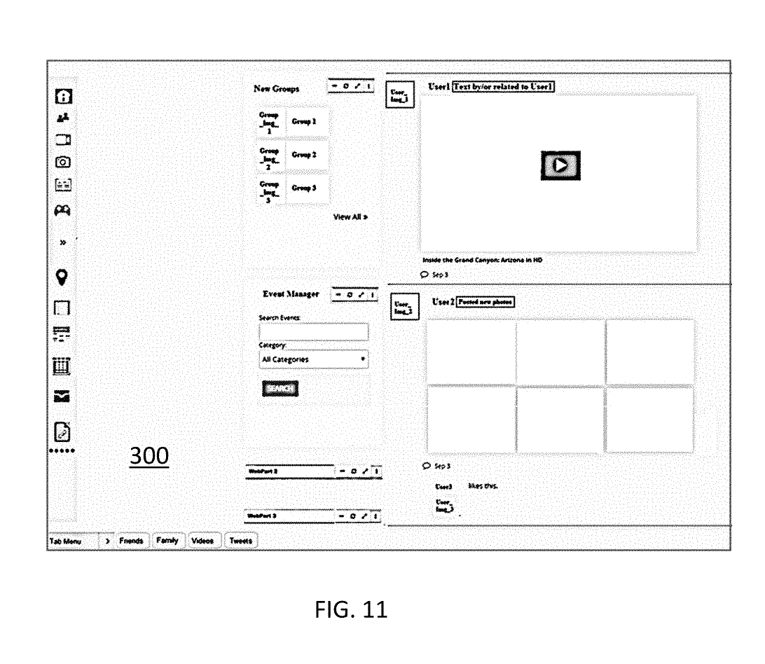

In accordance with an exemplary embodiment depicted in FIGS. 9-11, a User of GUI 300 may opt to select a setting button available at the top of the Web Part 340 to bring up a menu 350 as depicted in FIG. 9. Depicted in FIG. 10, a Menu 350 may have many options and may include a Remove Web Part option 360. A user may choose the option “Remove Web part” option to Remove the Web Part from the page. As depicted in FIG. 11, GUI 300 is shown after the Web Part has been removed.

### Creating Views Using the Web Parts

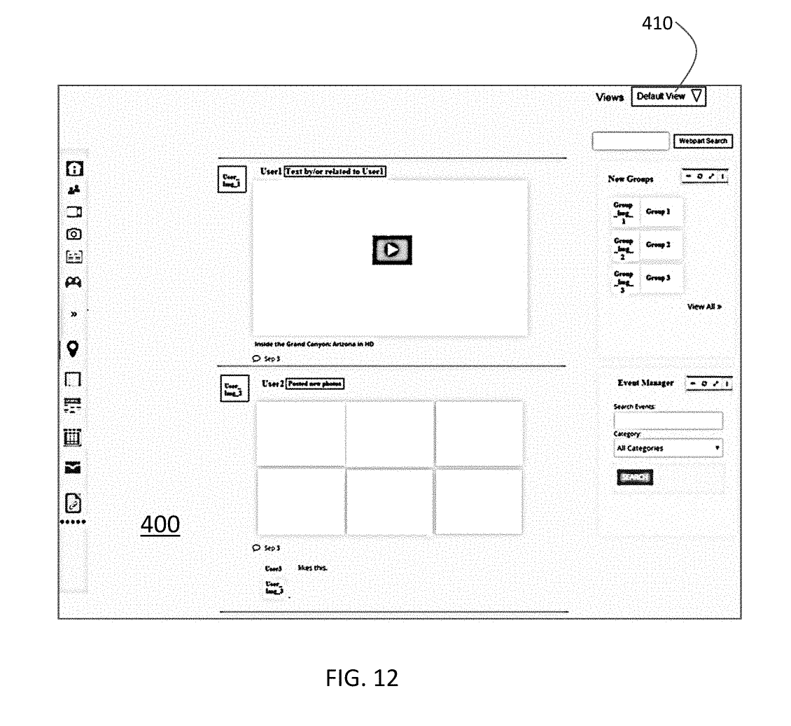

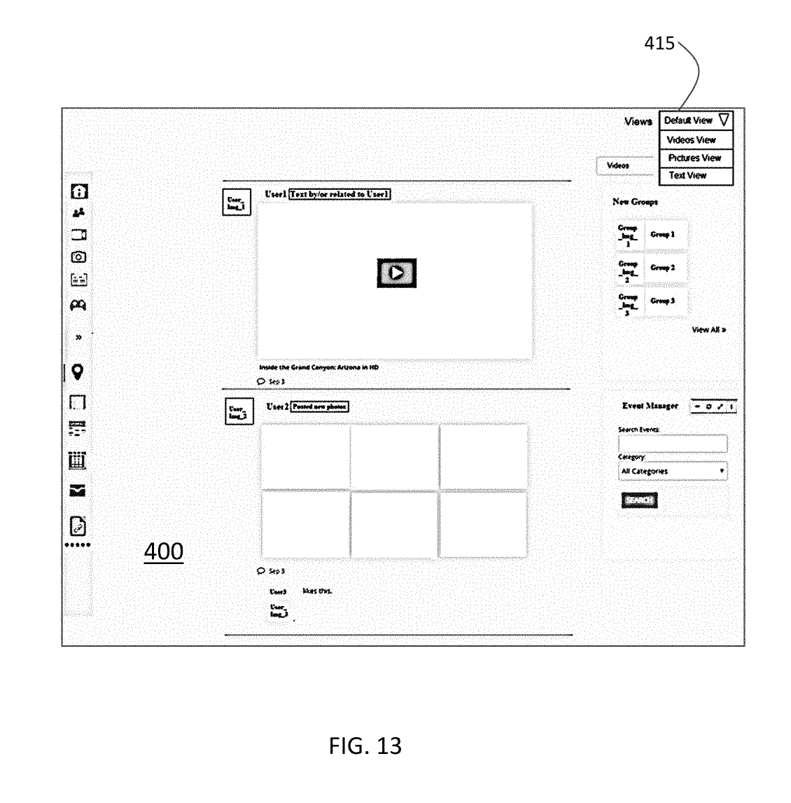

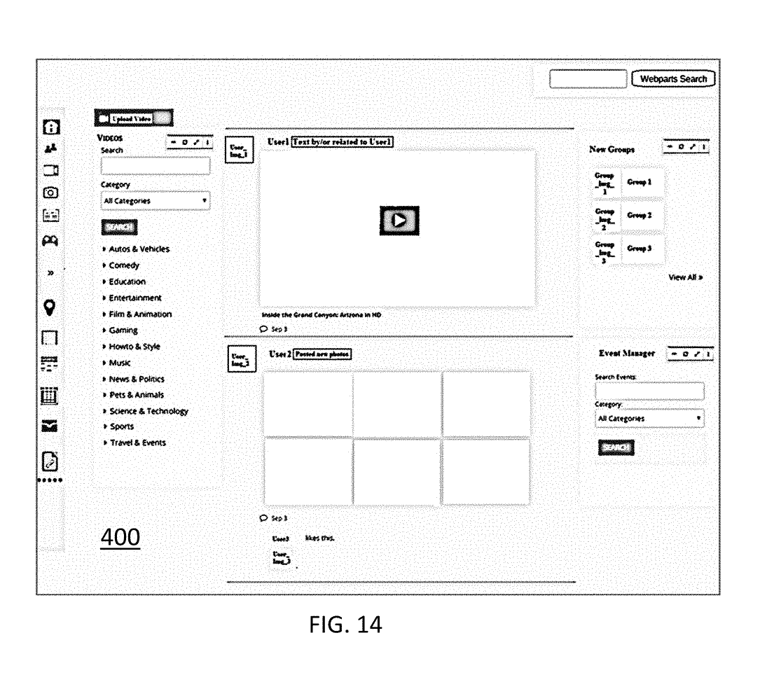

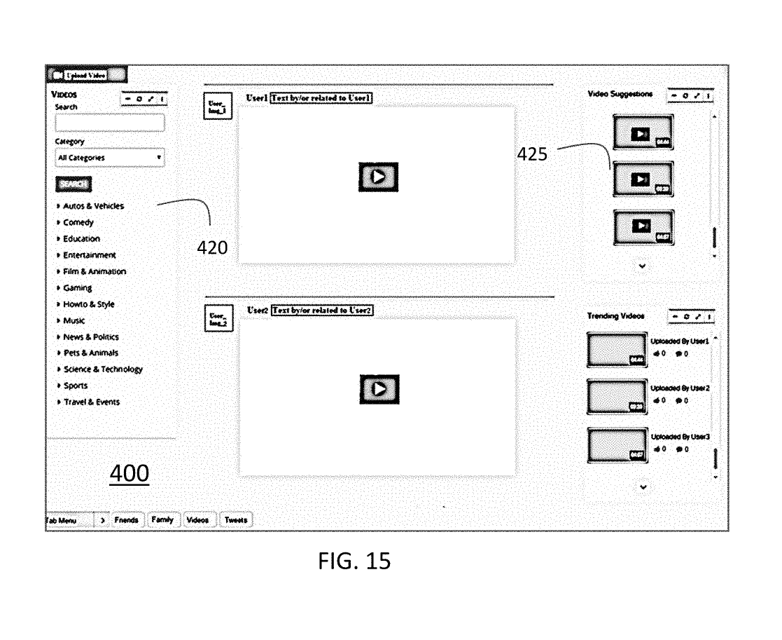

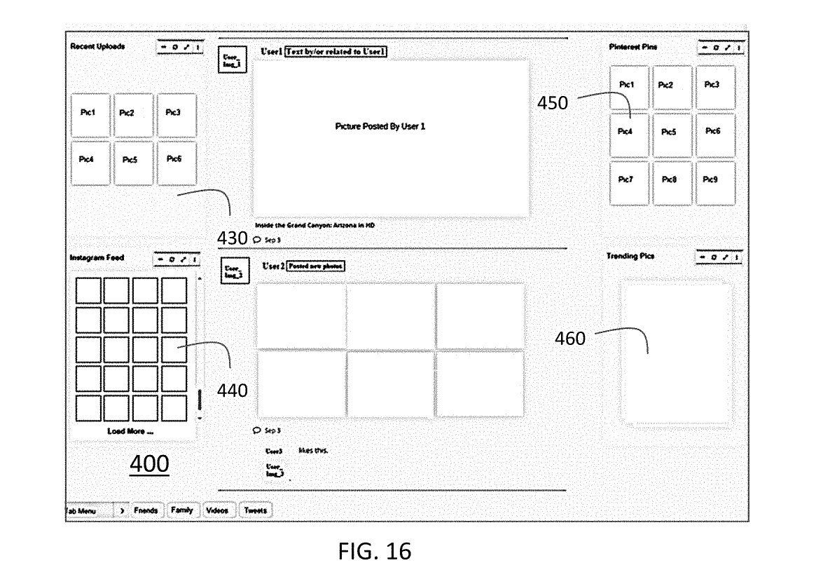

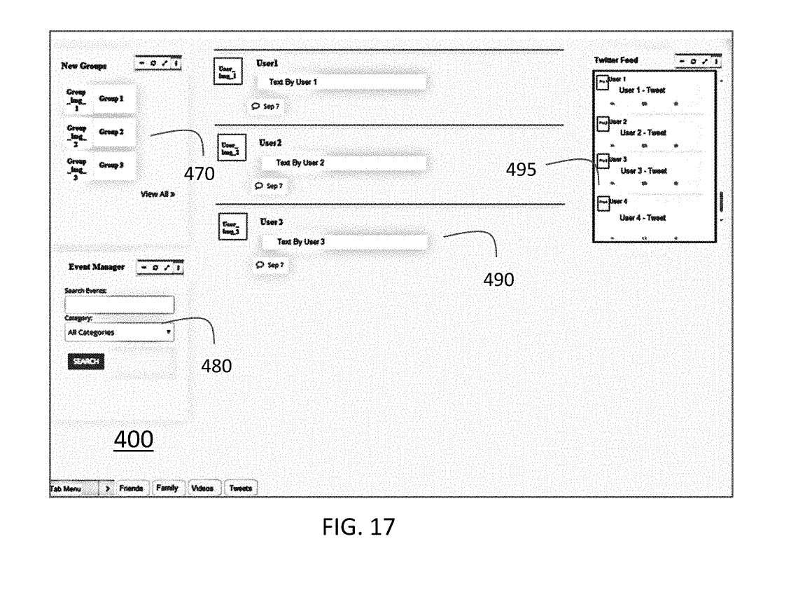

In accordance with an exemplary embodiment, after changing the design of the home page or any other page in the social networking site by modifying (adding, moving or removing) Web Parts on the page, the user may save the changed design as a View, so that once these changes are saved, the user can select this view and load the same page which includes the user's design changes. A user may make changes as many times as desired and can save it as a specific View. In one embodiment as depicted in FIG. 12 on GUI 400 a view indicator 410 may display the current view (Default view or other view) and when chosen, may provide a dropdown menu 415 with view selections as depicted in FIG. 13. As depicted in FIG. 13, there may be 4 Views available by Default (although any number of views may be possible) in the Social Networking System. The specific list of views and their configuration may be stored with an individual user's profile. In an exemplary embodiment the views may be as follows:
Default View (Web Part View depicted in FIG. 14);
Video View (Web Part View depicted in FIG. 15), which for example includes a Video Search Web Part 420 and a Video Suggestions Web Part 425;
Pictures View (Web Part View FIG. 16), which for example includes a Recent Uploads Web Part 430, an Instagram Feed Web Part 440, a Pinterest Pins Web Part 450, and a Trading Pics Web Part 460;
Text View (Web Part View FIG. 17), which for example includes a New Groups Web Part 470, an Event Manager Web Part 480, a Social Network Post Feed Web Part 490, and a Twitter Feed Web Part 495.
   Further in accordance with an exemplary embodiment, users of the Social Networking System may create their own Views based off of these default existing Views or by creating a new Page and saving the user created Views, which they can load whenever they need to use them.

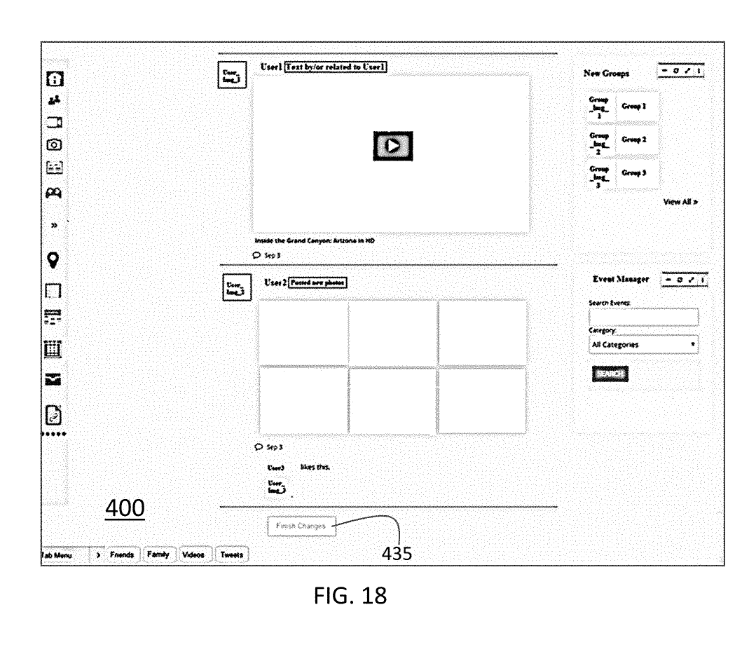

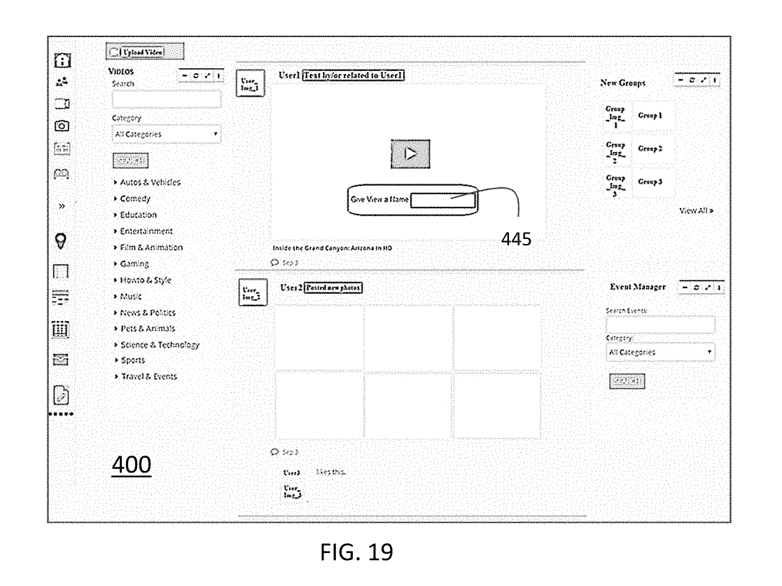

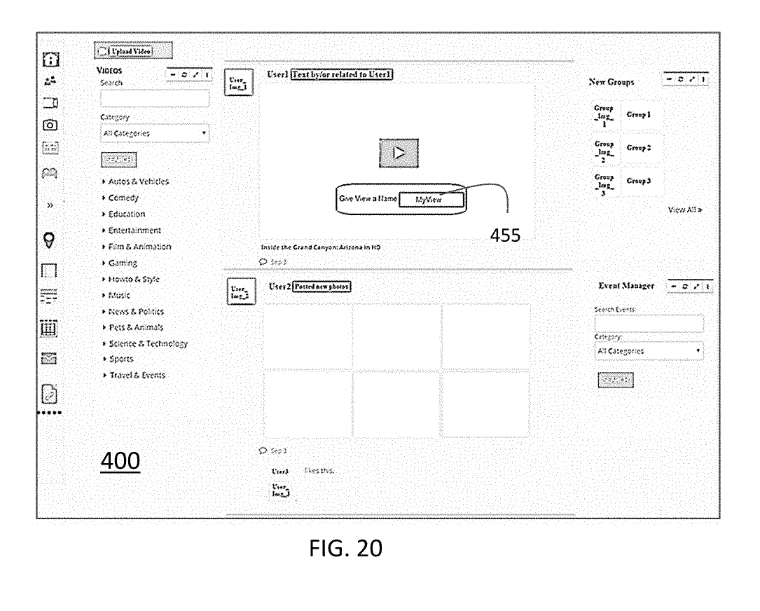

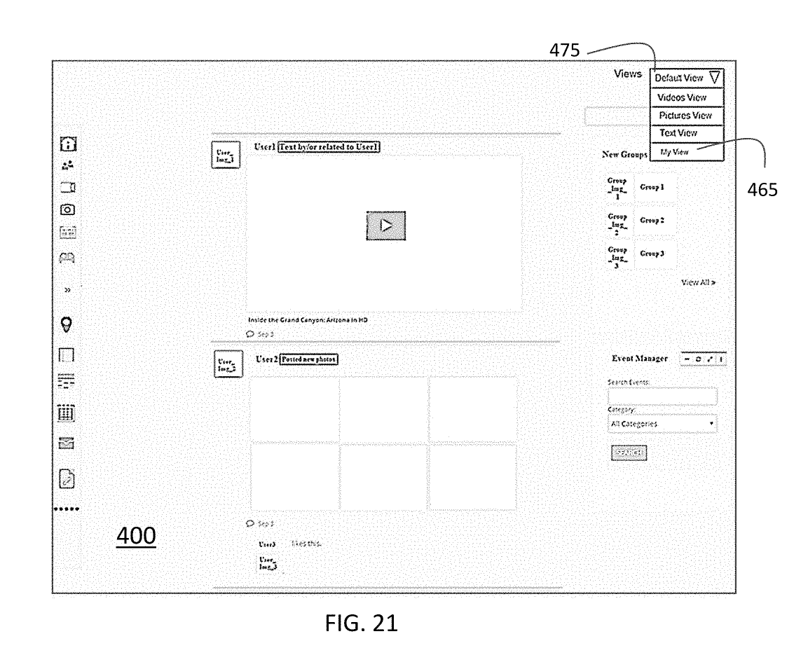

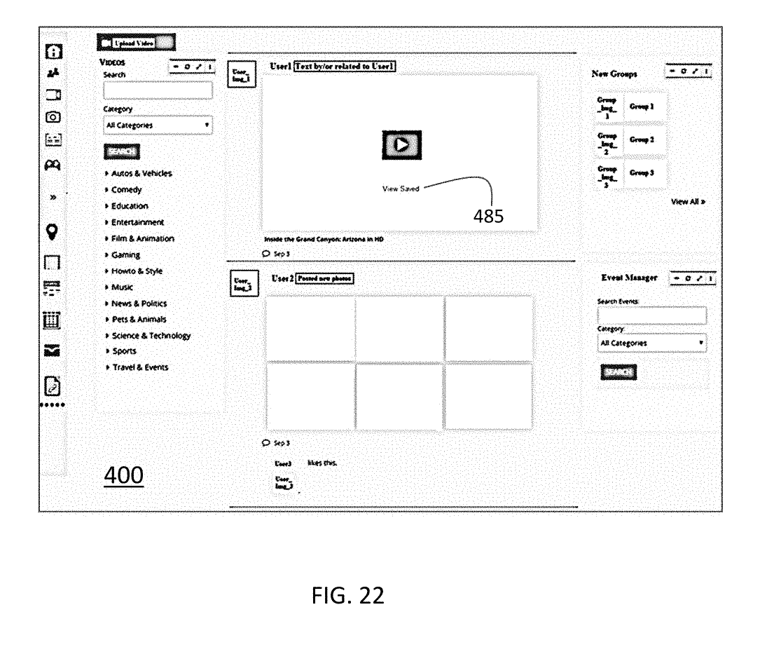

For example, a user may log into his profile and remove a Web Part (Videos Search Web Part 420, e.g.) available as part of the Default View (Web Part View FIG. 14) of the social networking system and move the other Web Parts around the screen by changing their positions. In one embodiment, as depicted in FIG. 18, a Finish Changes Button 435 appears at the bottom of the GUI 400, which when clicked prompts for the View Name 445 as shown in FIG. 19. As depicted in FIG. 20 a user may provide a name 455 to the view. As depicted in FIG. 21, after Saving the View by giving a specific View Name (My View, e.g.), the new view name 465 (My View) appears in the drop-down list 475 under user profile along with the Default Views. After saving the View, as depicted in FIG. 22, the View Saved message 485 appears on the screen of GUI 400.

When a user on the Social Networking system changes his existing view to Videos View, only the video content with little or no text content is available on the social networking home page, or the user feeds only the posts having videos are displayed, uploaded videos, or the Web Part with the option to upload videos and/or related videos Web Part. Trending videos and similar other video content Web Parts may be displayed on the sides and the other available space on the page except on the space for advertisements.

When a User on the Social Networking system changes his existing view to Pictures View, only the image content with little or no text content is available on the social networking home page, or the user feeds only the posts having pictures/photos are displayed, the recent pictures web part and/or tagged pictures web part or trending pictures and similar other image content Web Parts are displayed on the sides and the other available space on the page except on the space for advertisements.

When a User on the Social Networking system changes his existing view to Text View, only the text content with little or no video/image content is available on the Social Networking home page, or the user feeds only the posts having text are displayed, the twitter feed Web Part and/or or trending post articles web part and similar other text content Web Parts are displayed on the sides and the other available space on the page except on the space for advertisements.

In accordance with exemplary embodiments, Creation of Views is not just limited to creating the Views using Web Parts but they may be created using other social networking objects such as RSS Feeds, or the combination of RSS Feeds and Web Parts or any such combination of similar social networking objects.

### Auto-Save View by Using Settings in Social Networking System/Site

In accordance with an exemplary embodiment, when a User navigates to different pages or views, or logs out of his profile, signs back into the social networking system, and loads the “My View”, which is the View created by him, and starts modifying the View, the changes in the design of the View may optionally be auto-saved. However, if the User wants to save the new design changes on this View as a different View, the User can click a Settings button on the GUI which changes the Auto-Save (For Views) option to OFF, if it is set to ON.

If the User inadvertently forgets to save the changes that they made after modifying the Web Parts, and clicks on another menu or tries to navigate to another page, a message may be displayed which prompts the user to save the changes as a View. If chosen to save, the User can save the design changes on the page by giving this View a name. This newe View may then be reloaded later after the user has changed the View to some other existing view or a new view. The View feature gives a user more control of their pages such that they can see what they want to see but not what some other entity has dictated is only available to them.

### Overlap Web Parts

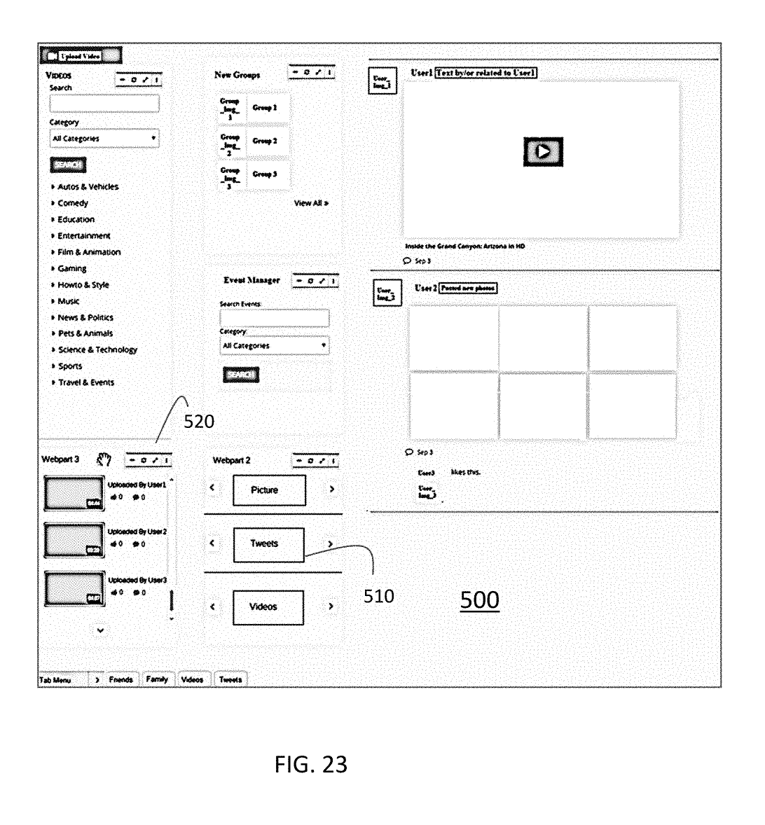

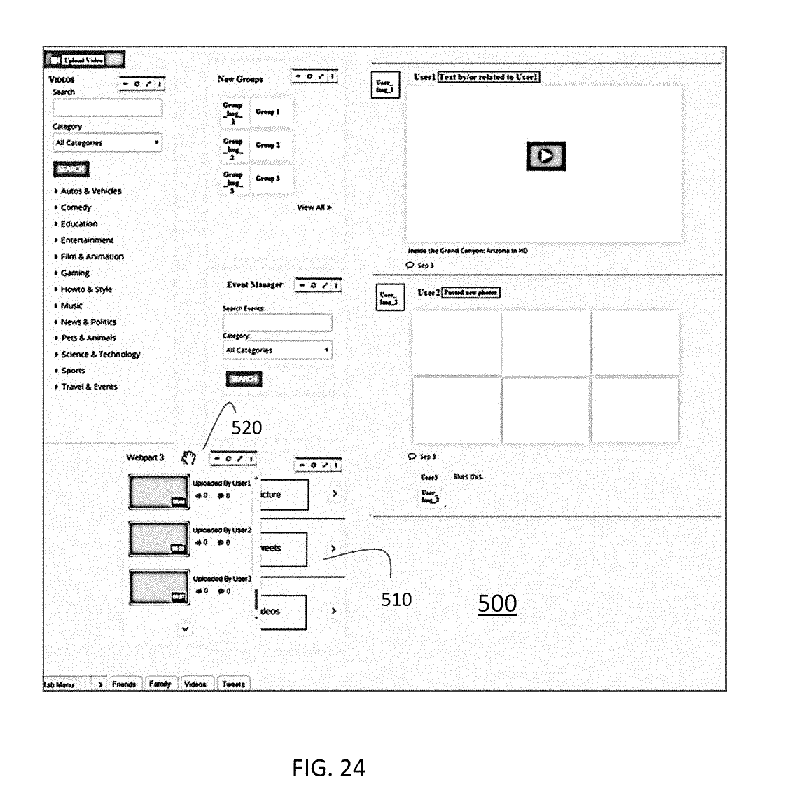

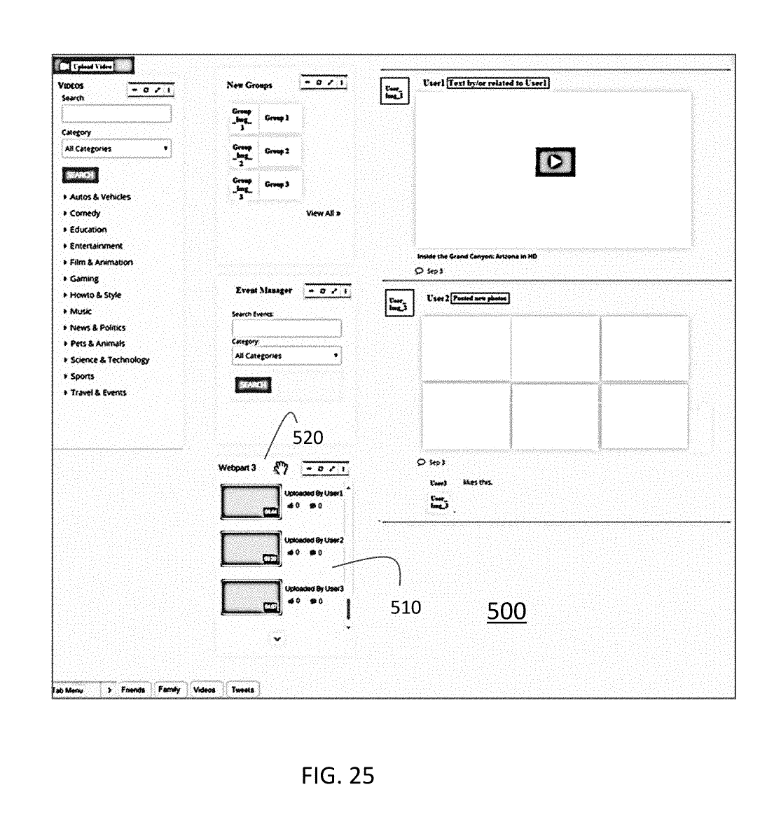

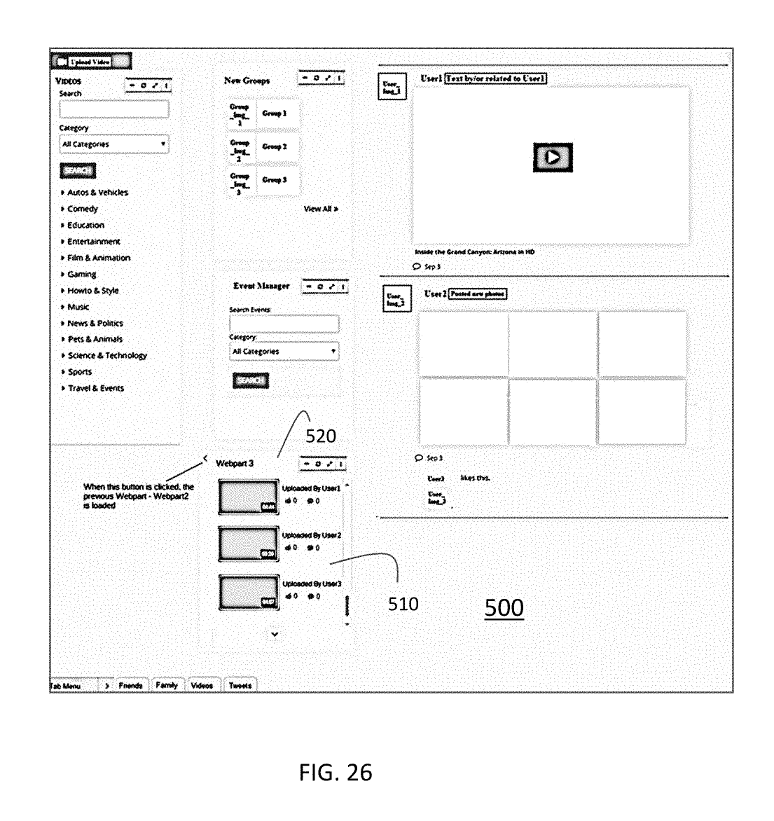

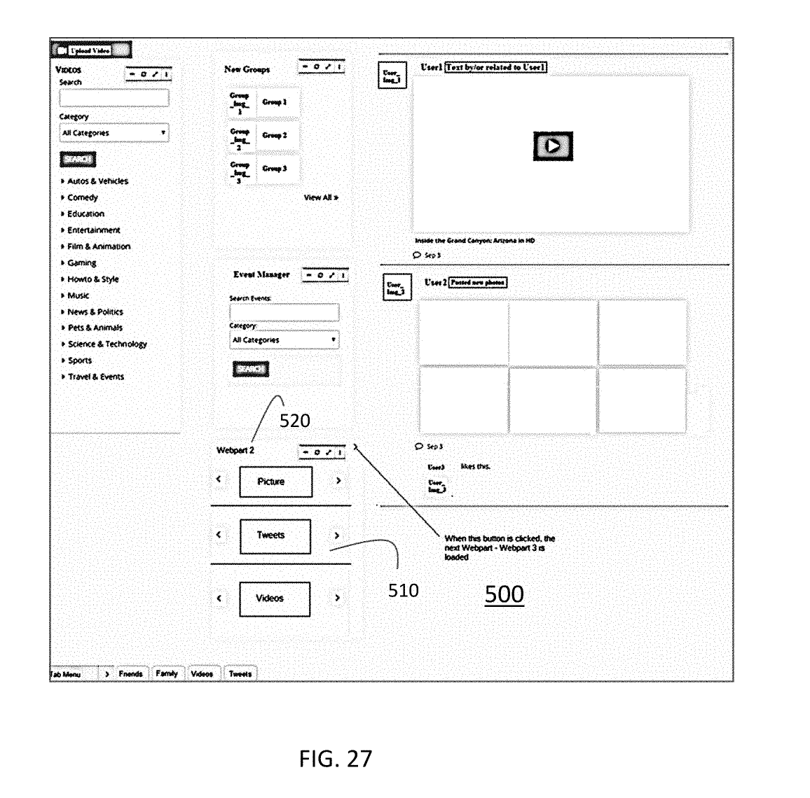

Referring now to FIGS. 23-27, in accordance with an exemplary embodiment, a User may have the ability to place one Web Part over another Web Part on a Social Networking GUI 500. FIGS. 23 and 24 depict a first Web Part 510 being overlayed with a second Web Part 520 on GUI 500. When two or more Web Parts, such as Web Parts 510 and 520 are stacked, for example over one another in this manner, the User may switch between the two or more Web Parts by using the Previous and Next Arrows beside the top of the Web Part available when one is overlapped by the other as depicted in FIGS. 26 and 27. This feature of overlapping and switching within the stack of objects is depicted in FIGS. 23-27. This feature also provides more efficient use of Space on the Social Networking GUI 500 especially when space on the GUI is hard to manage at times, in that a User may wish to have more Web Parts available than could otherwise reasonably and comfortably fit on GUI 500.

### A Virtual or Digital Assistant in a Social Networking System/Site

In accordance with an exemplary embodiment, there may be a digital assistant within the social networking site/system that includes a user interface with the social networking system itself. The digital assistant may be a digital agent. This digital agent, within the social networking system may receive user voice input or user information in the form of human natural language speech which includes unstructured data, and uses Natural Language Processing (NLP) to understand human speech as it is spoken into a microphone and based on other user input to perform tasks or operations, or send information back to the user by speech.

The Digital Agent in a Social Networking System/Site may be a communication tool which reduces or eases the human efforts in Social Networking System by listening and understanding to user voice input and performing the related task based on the input with user putting less efforts, with/without having the user to manually type or select, search or perform tasks such as messaging, posting, searching (searching friends, web from social networking system, data, etc.) or navigating across different pages or navigating or clicking through different options or menus, or Web Parts in the same page.

As an example, the digital assistant in the social networking system is referred to as “Ainika” but can be called or referenced by any name. In some exemplary embodiments, there may be different Digital Agents available to the User in the Social Networking System from which User may pick one to communicate with. Some of the examples of tasks that can be done by the digital agent in the social networking or the social networking system include but are not limited to:
Sending Messages on behalf of the User.
Clicking on Menus, tabs, sidebar, links, or any other objects.
Playing songs, videos, music within Social Networking System

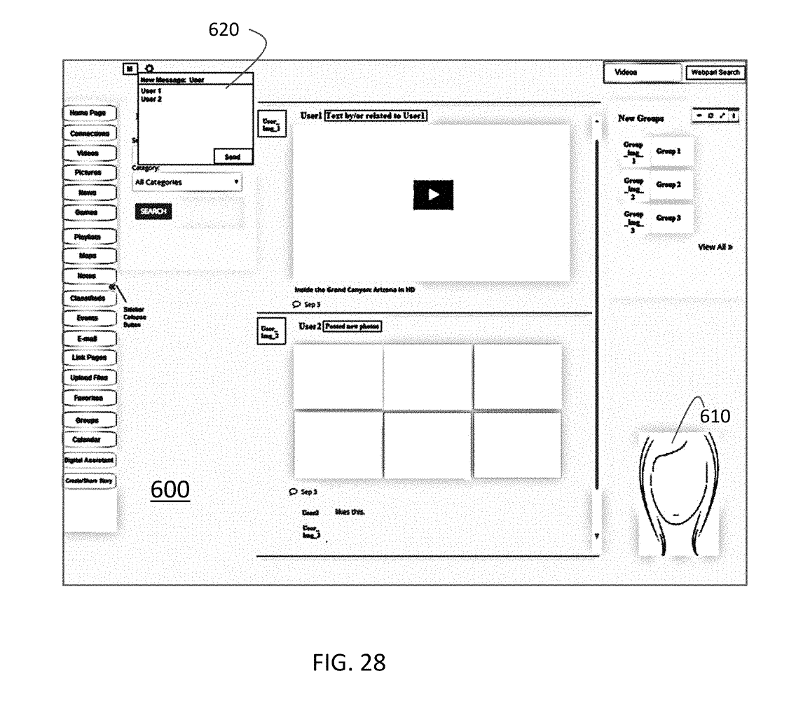

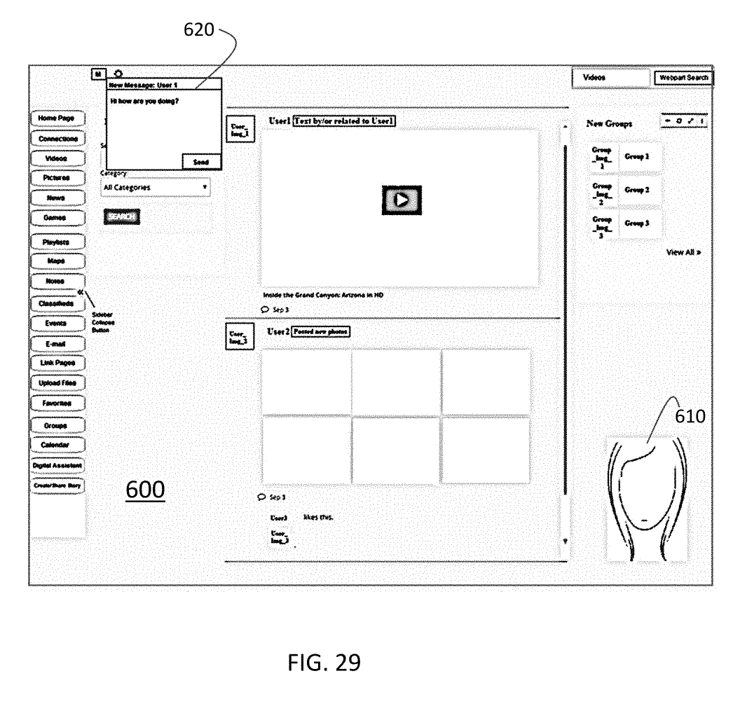

In accordance with an exemplary embodiment depicted in FIGS. 28 and 29, GUI 600 is shown having a digital assistant 610 activated. Digital Assistant 610 may be a voice activated and voice response system using natural language processing alone or in combination with artificial intelligence algorithms for processing speech. In an exemplary embodiment, the User turns on the digital agent Ainika, and says any of the following:

Message User1, Send Message to User1, Ainika will try to send a message to User1 with the user voice input, it may confirm with the user, if the user is wanting to send a message, or message to User1.

Initially it might take couple of attempts for the Digital Assistant to get used to the User's voice and Ainika may speak to User by asking the User to repeat if it didn't catch what exactly the User was speaking such as—I'm sorry, I didn't get that right, can you please repeat and when the User repeats may follow the User instructions.

Ainika may also confirm instructions given by the User by speaking as—You want to send a message to User 1, right? Alternatively, a depicted in FIG. 28, if Ainika does not know what user to message, the New message User window 620 displays possible Users to message, either User 1 or User 2 in the example depicted.

When the user speaks the message, Ainika may open a message window 620 and types the message and sends the message as per User's instruction, as depicted in FIG. 29.

In accordance with an exemplary embodiment, Ainika may prompt a user if the message needs to be sent as a Voice message or Text message and if the User says Voice message, a voice message will be sent, and if the user says Text message, a text message will be sent. Further, the User can ask Ainika to Play Music, Songs, Videos, Movies or any Similar Audio, Video Files under his profile in the Social Networking System.

If, for example, the User asks Ainika to play a song, it can prompt the User asking which song to play, then when the user says a particular song name, it can search the Social networking system for the song (which might be in the audio or video format). The search may include searching Web Parts (both internal and external), or any playlists that the user might have in his page, Videos, Video Posts, Music or Audio Posts, Video Files, Audio Files, etc. and when the song is not found in the social networking system it may search the Social Networking web more generally and display the results. If found in the Social Networking System, Ainika will play that song, if it finds more than one song with the same name, based on the results, it can communicate with the user by speaking to user and giving the information that there was more than one song or result found, and if the user asks it to play the song by mentioning an artist's name, if the artist's name is available or known in the social networking system, Ainika will play that song. If there are duplicate results with the Date, Ainika may prompt the user by asking which dated file to play. If there is an Audio and a Video format of the song, Ainika may prompt the User as which format to play and based on the user input, plays the song with that format.

A User may communicate with Ainika to Search Videos, Audio Content and any text data in similar ways. For example, a User may ask Ainika to navigate different menus or click on different options, for example, when the User asks Ainika to click on Favorites Menu, if in that page there is a favorites menu available, Ainika will click that menu and navigate to the Favorites page.

Further, Ainika can keep track of all the activities performed everyday by user and User can view his Recent Activities by asking Anika to display all his recent activities by Day, Week, Month, Year and by keep tracking of an Users daily activities, Anika can learn the behavioral pattern of the Users and may provide useful suggestions to the User. The User may set reminders by speaking to Anika and it reminds the user by speaking to the User minutes/hours/day (based on the time set by the user) before the reminder time set, reminding the user about the reminder on any device where Digital Assistant is installed/and the User has logged in to Ainika based on User Settings.

Users can add reminders such as going to grocery, scheduling a doctor visit, attending a concert on certain date and certain time, etc.

### Miscellaneous Web Parts Functionality

In accordance with an exemplary embodiment, a web part in the Social Networking System can hold information of other web parts. For example, a user may have a web part that is used to hold a Video Web Part, an Audio Web Part, a Text Web Part, or a Pictures Web Part combined into a Single Web Part. It can also be a collection of different combinations of Video, Pictures, Audio or Text Objects or combination of feeds of these objects.

The horizontal menu and the vertical side bar can be combined to one web part and used as a common template across different pages of a user within the Social Networking System. The same template web part can be split into two Web Parts menus and sidebars and the user can use them as required.

Apart from the Web Parts that may be available by default in the Social Networking System, developers or the users of the Social Networking System can develop Web Parts using Web Parts API available to them. Adding third party Web Parts can greatly enhance the social networking experience as users can search and include any Web Part that they like in their pages.

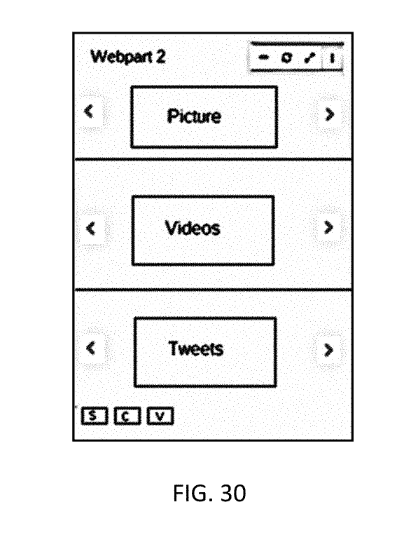

In the existing social networking systems when users share any data such as text/video/picture on the Home Page with other users in the existing social networking systems or any other websites or social media sites, users share one at a time i.e. user may post a pic, or video in one share. But using a Web Part that is made of Video, Pic, Tweet/Text, or Audio Feeds, all combined or different combinations of these objects, a User can share a collection of objects in one share as a web part instead of sharing these as individual objects, depicted in FIG. 30. These web parts can be shared with different users on the social networking platform and these can be shared by clicking on the “S” Button (Box below the Tweets Web Part Object), commented by clicking on “C” Button, or voted by clicking on the “V” Button, etc.

In accordance with an exemplary embodiment, an internal Web Part can be removed and can be restored by searching the Web Part in the Web Parts Search and placed back anywhere on the page. By default, the restored Web Part goes below the web part that is on the bottom left corner of the page. The internal Web Part is the one that may be available in Social Networking System by default. The Social Networking System can also include external Web Parts which are developed by Developers that when removed can be restored by Searching the Web Parts in the Social Networking System. These external Web Parts are available and may be stored in a Web Parts Directory.

### Share Notification

In accordance with an exemplary embodiment, a User may share notifications with his friends, everyone, specific people, etc. in the User's Network/Connections in the Social Networking System based on where the User is currently located. The Social Networking System App may be installed on any gadget or electronic device and may include the Digital Agent Ainika on the device. A User can share the notification by himself/herself manually or by asking Ainika to share this notification by speaking to it. The app itself may be used as a Digital bot where instead of communicating to an Avatar such as Ainika, a User may directly communicate with the social networking app.

For example, when at a movie theater, the Notification may include the Post such as “At a Movie theatre at Location1, or watching a movie”

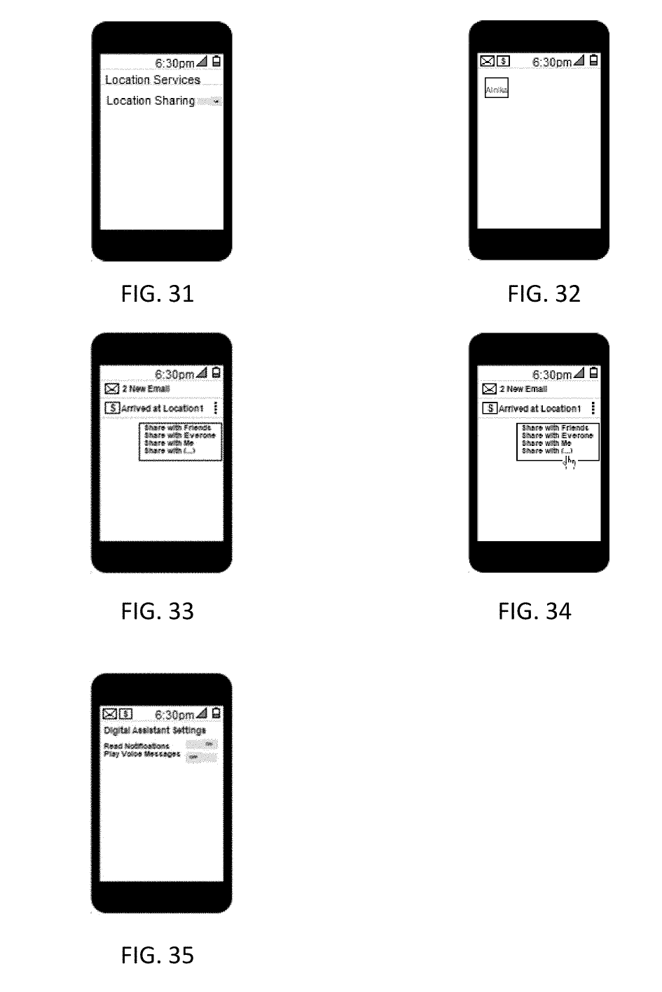

This notification may appear when the Maps feature is turned on User's Mobile Device, where the Maps when turned on can track the User Navigation and when the user stops at a place, notification appears on the Mobile Device. In an exemplary embodiment, a User can edit and share the pop up notification, share the information as is, or ignore the notification/pop-up. These notification and mobile features are depicted in FIGS. 31-35 as shown and described. Further, when a notification pops up on which may include messages received to the User from other Users, the User can ask Ainika to Send a reply or reply to the message by saying “Reply to User1” if a message is received from User 1 and Ainika would reply to the message by including the body content that User communicates with Ainika while sending reply to message. A User may also set the options using Settings so that when notifications are received Ainika can read those notifications as depicted.

### Create and Share Story

In accordance with another exemplary embodiment, Users on the Social Networking Website/System can share with other users their daily/weekly/monthly/quarterly/yearly activities in the form of sketch/doodle movie/clip called Story. A Story is a clip/movie/video (short or long)/cartoon/animation of a Users activities/interests/hobbies in his daily life that a User Can Create and Share with others.

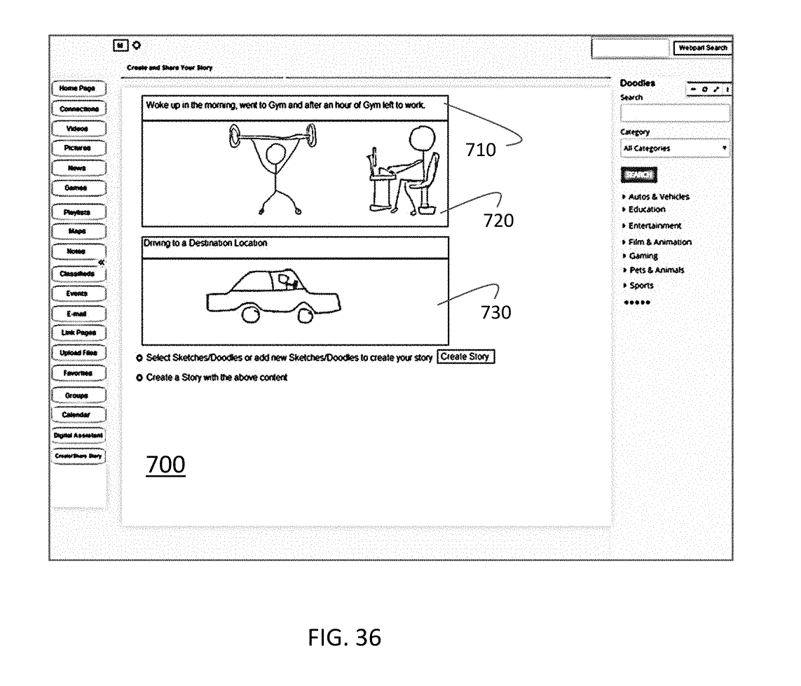

As depicted in FIG. 36, to create and share a story on GUI 700, a User can click on Create/Share Story menu and type the content and as the User Types the text content in the text box 710, which may be multi-line textbox. A sketches/doodles related to the text automatically appear below the text in the box 720 below the multi-line text box.

The images may also appear in the boxes in the Image Box, box present below Text Content Text Box and the images in the image box may be displayed one after the other, such as seen in box 730, in the order of the text being typed as the user types in the text.

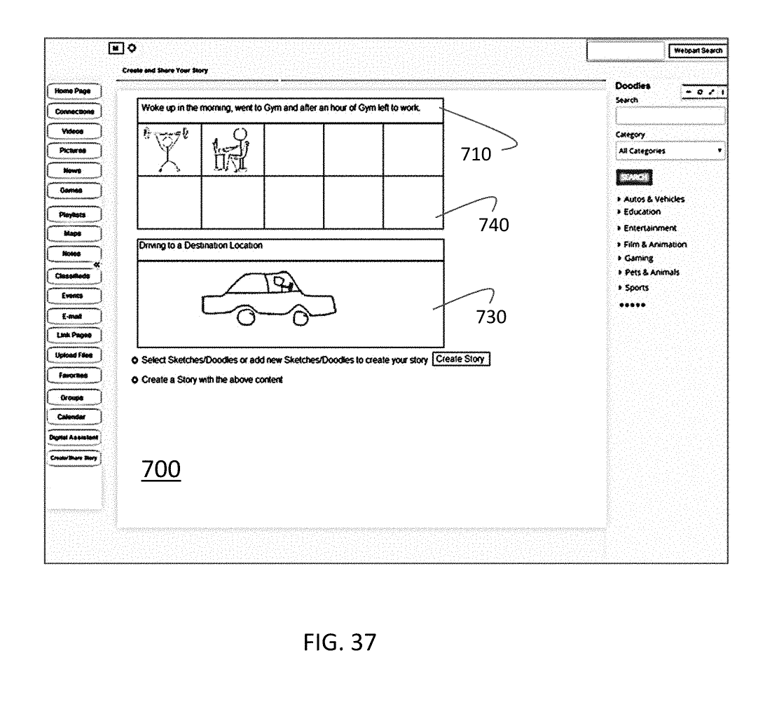

In an exemplary embodiment, depicted in FIG. 37, the images may also be displayed within small image boxes present inside the main image box 740.

In accordance with an exemplary embodiment, there are 2 Options from which a user can create a Story:
Select Sketches/Doodles or add new Sketches/Doodles to create your story.
Create a Story with the above content.

With the First option, a user can select all of some of the Sketches/Doodles that appear when the text content is typed, and User also has an option to add new Sketches by searching for Doodles in Doodle Search available on the right side. A User can type in the User activity or doodle/sketch that the User is looking for in the Search Text Box and click on Search and this would bring up the search results from which the User can select the Doodle/Sketch the User is interested or User may also click on the Doodle Categories and browse to select a Doodle/Sketch and add it to the existing list of the Doodles and click on Create Story Button beside the first option to create a Story. A Story may be a clip/movie playing the Sketches/Doodles one after the other in sequential order or based on the Order of the User selection of Sketches/Doodles.

Using the Second option, based on the User Text Content, and based on the Sketches/Doodles related to the Text Content a Story is created which is again similar to playing the Sketches/Doodles.

After the story is created, the User may share the video/clip 750 created to his friends, friends of friends, everyone or to any other user/users as his daily/weekly/monthly/quarterly/yearly Story. There may also be “Related Stories” displayed below, above, left or on the right of the User Story posted and shared with others where the stories related to User text content or the story appear.

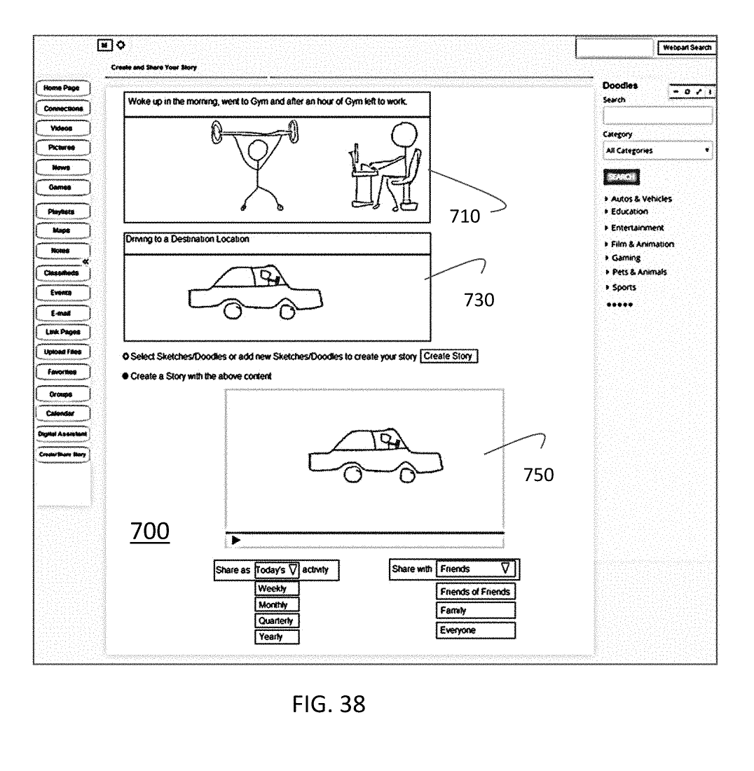

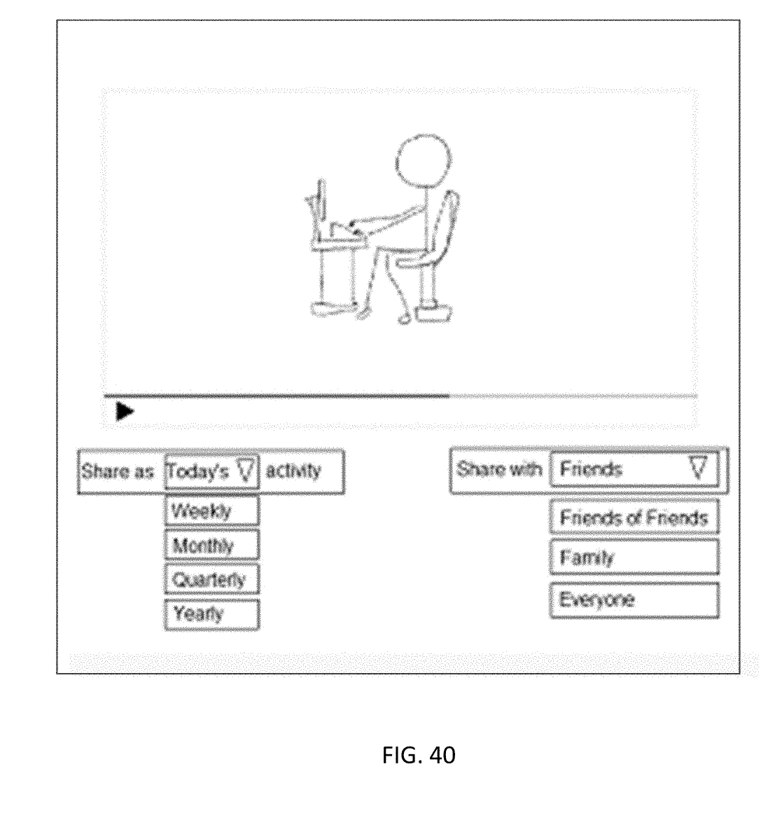

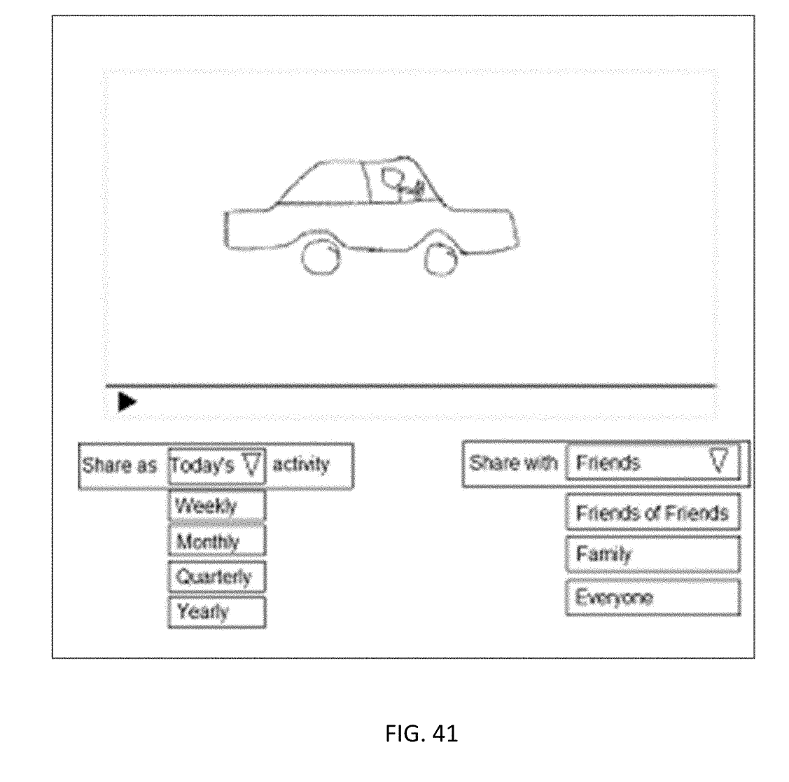

For illustration purposes only, the images depicted in the FIGS. 36-41 are sample images, the images may be colorful, and along with the images there may be background audio related to each image or an audio for all images. A User may be able to add audio to the Story while the story is being created or after the story is created. The user may also have an option to set where the social networking system itself creates a story on behalf of the User and User may have an option to enable auto post the System created Story or once the story is created, is available to the User to view it and User may share or ignore the Story created by the Social Networking System. Based on the User's activity on the social networking system, such as posting and sharing feeds, videos, pictures, text data, chatting, playing games, uploading or watching videos or listening to music, the social networking system may keep track of every activity of the User and create a story based on these activities and may use the images pertaining to these activities while creating a story. A User may have an option for the social networking system to generate daily or weekly or monthly or yearly stories.

An example of a weekly story created by the social networking system may be such as:

In a week beginning on Monday, if the user is online on social networking system, types a text data message (which may not be the text pertaining to story creation where the user types in text and selects one of the two options to create a story i.e. Select Sketches/Doodles or add new Sketches/Doodles to create your story or Create a Story with the above content as discussed above) and shares it across the social networking system with his network/connection of other Users. Depending on the text content, this data may or may not be part of story. For example if the user's message includes text that is a mix of languages or text that is not easily understandable by the social networking system, text that lacks meaning, this text may not be a part of story and in contrast if user types in a message that is meaningful and understandable and has a meaning in real world such as “going to University”, the story may include data related to this text.

On the next day Tuesday, the User, for example, may be offline from the social networking system.

Wednesday, the User is back online and continues to be online for the rest of the week. On Wednesday the User goes to work and turns on the Social Networking System to shares message with other users online such as “at work”.

On Thursday the User may for example, post a video or watches one, and chats with Friends.

On Friday the User sends a message to other Users

On Saturday, a User may be carrying his mobile, tablet, or any electronic device on which the social networking system app is installed. The User may be online on the Social Networking site, on any of these devices, and has maps on the social networking system/app turned on. If the User goes to grocery shopping in the morning and in the evening, goes a movie theatre, the data is tracked by maps and as discussed previously, in the notifications, the data can be part of the story.

On Sunday, if the User has maps turned on in the social networking app on his gadget and is online on the social networking system on his mobile or any electronic device and travels to a restaurant and visits church.

At the end of the week Sunday evening or at the beginning of the week Monday morning, the social networking system may create a story which includes a video/clip of all or most of the User activities, where the clip may start with animation of—a Sketch travelling to University, Working, Watching Video, Chatting with Friends online, Messaging, Grocery Shopping, Visiting Movie Theatre or Watching Movie, Visiting Restaurant or eating at Restaurant and Visiting or Praying at Church.

In the above Story, Watching Video, Chatting with Friends Online, Messaging may be clubbed together as one online social activity Sketch during the Story creation, for example.

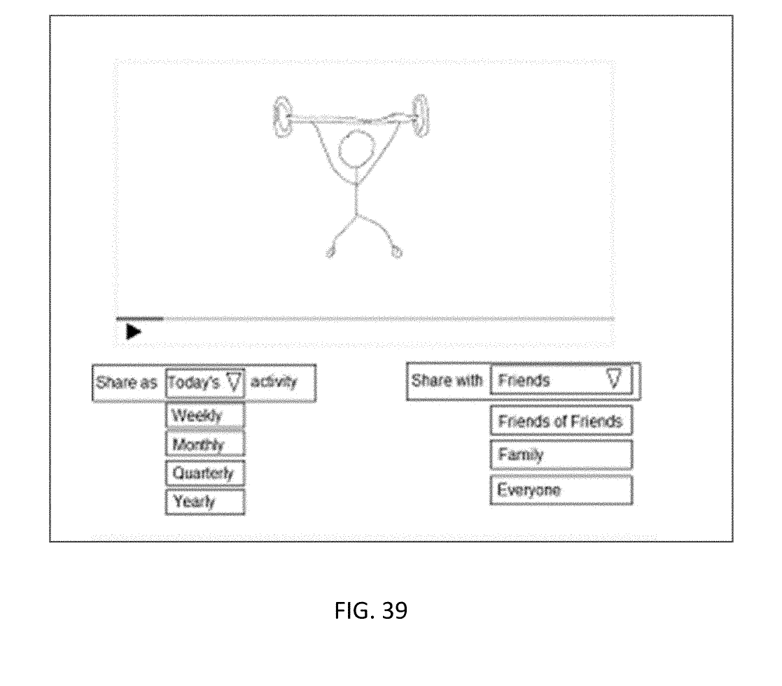

Further, after the Story is Created, it may be shared as a notification to User where he can view it and may be able to edit the Story and the User can share the edited Story or share the story as is or ignore the story, see e.g. FIGS. 39-41.

### Sidebar Visibility:

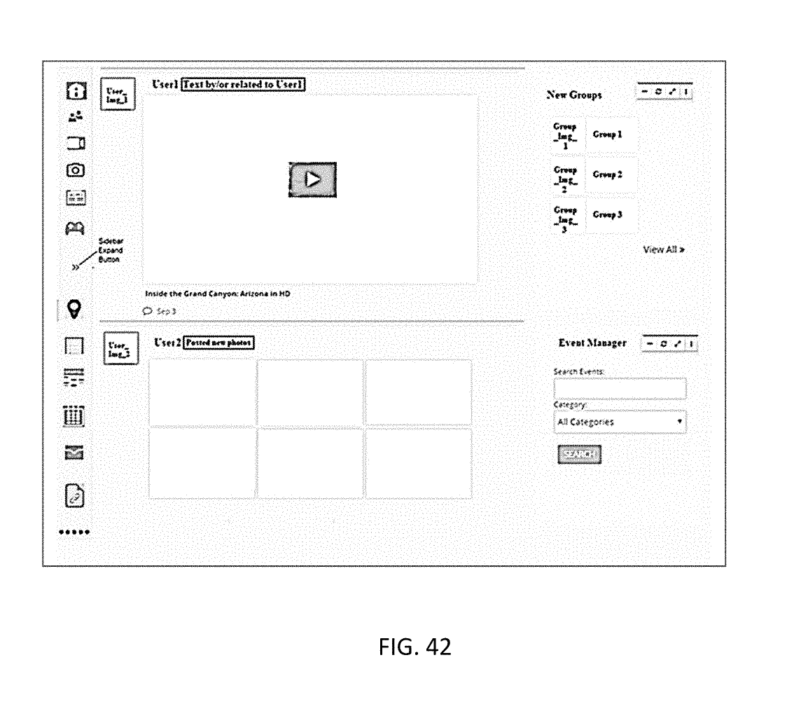

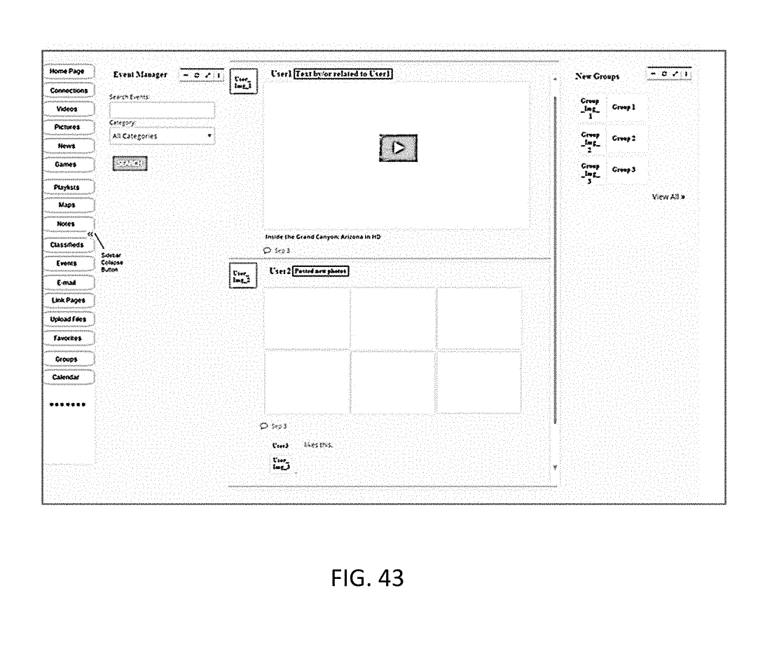

In accordance with an exemplary embodiment, there may be a Side bar that is not completely visible by default, i.e. a sidebar just with menu icons is displayed and clicking on the Sidebar Expand Button will open the sidebar with links and click back on the Sidebar Collapse Button will collapse the Sidebar back to the Sidebar with menu icons, as depicted in FIGS. 42 and 43.

In this way, a user may access links only when desired. Having this ability also provides more real estate on the screen by hiding the sidebar when not required or not in use.

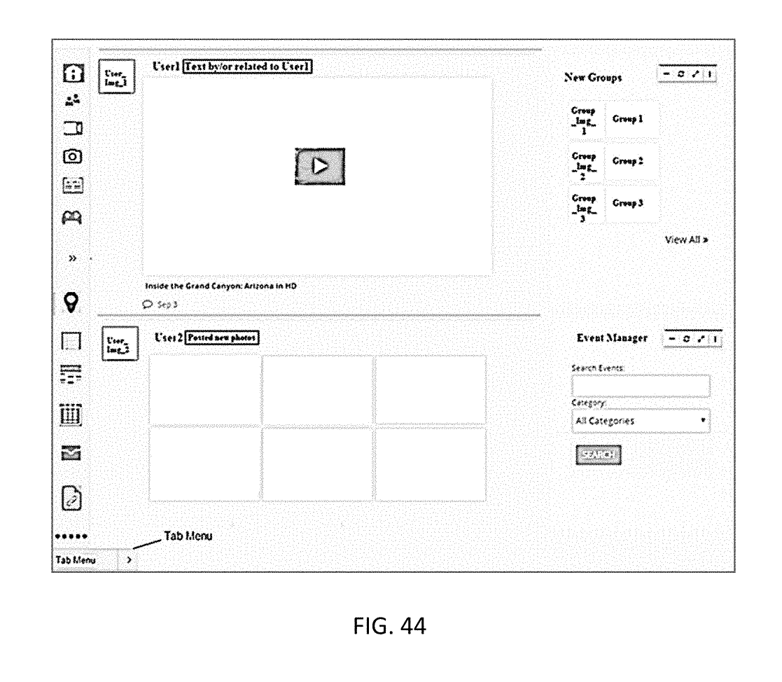

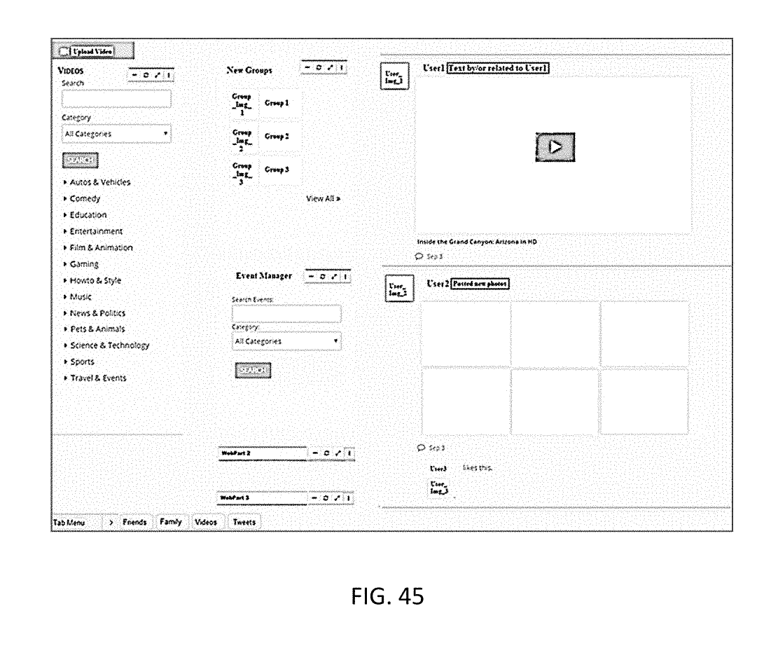

A similar functionality may be used for a Tab Menu as shown in FIGS. 44 and 45. Clicking on the Tab Menu will open the Tab Menus with links to different page navigations and click back on the Tab Menu operates to hide the Tab menus.

### Adjustable Sidebar/Menu:

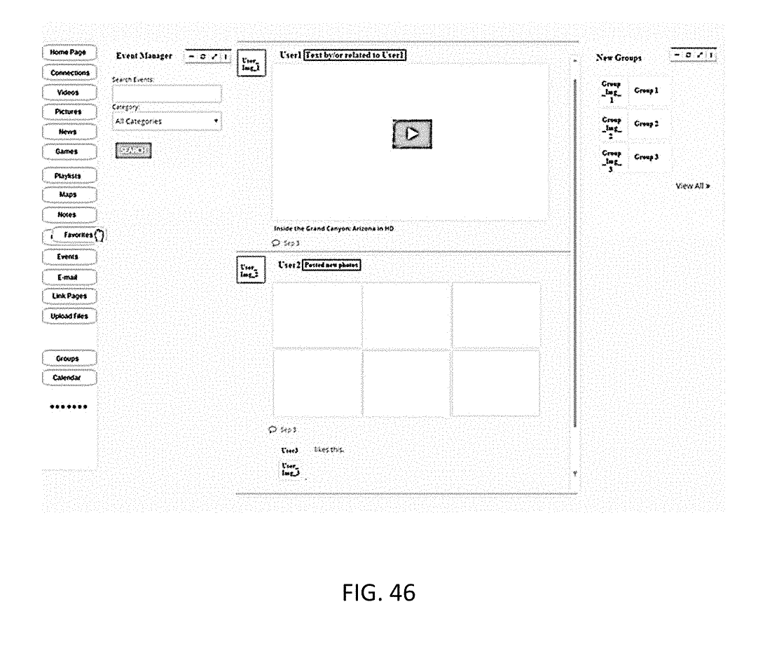

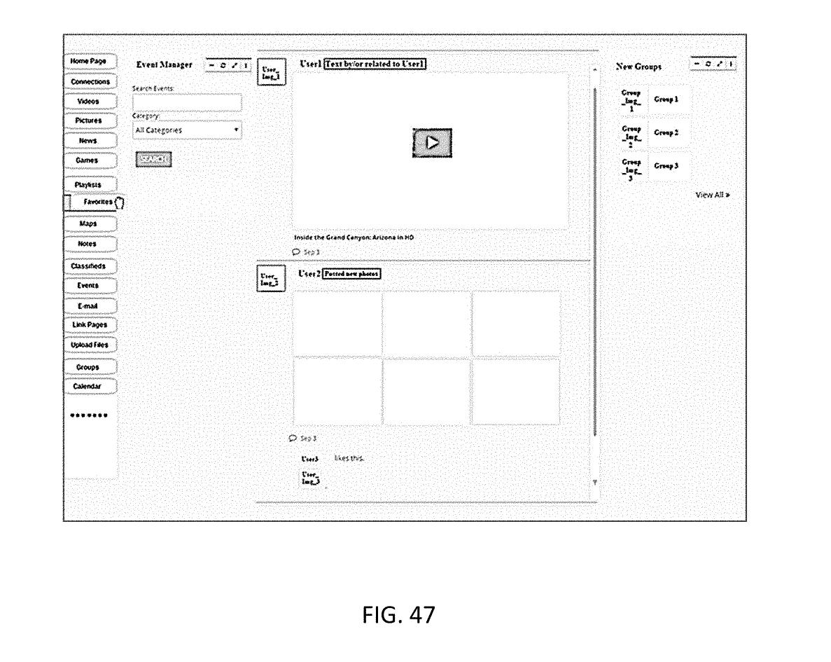

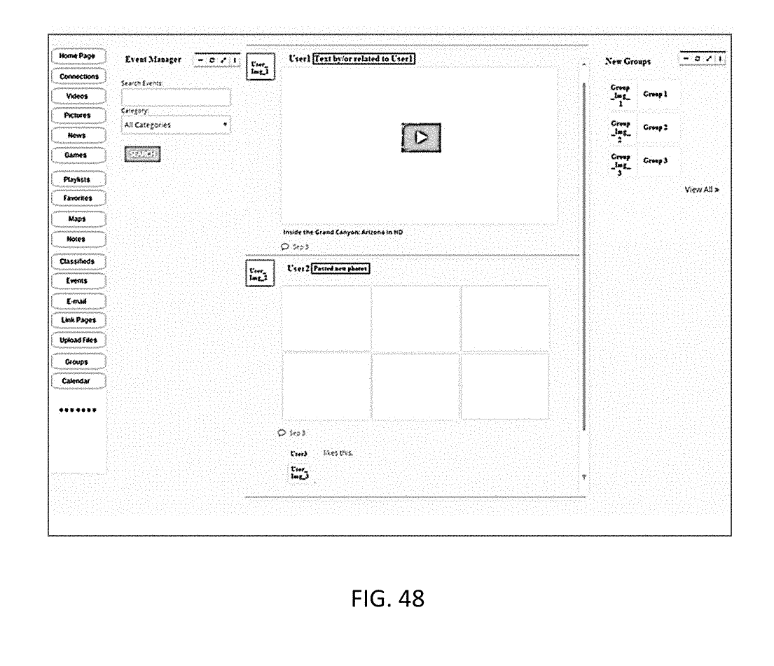

In accordance with an exemplary embodiment, as depicted in FIGS. 46-48, any of the menu options on the sidebar can be moved up and down across the sidebar. A user can change the order of the menus in the sidebar by moving the menu top or down across the sidebar as shown in FIGS. 46-48 where the action of changing the location of the “Favorites” menu item is depicted.

### Recent Posts in Social Networking System

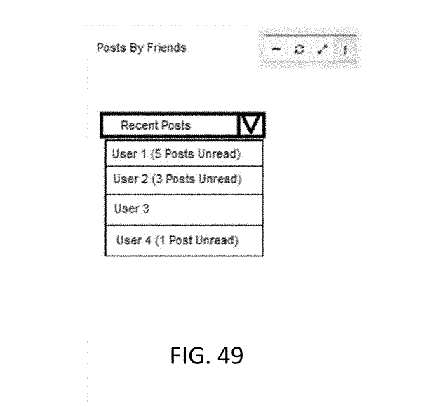

In Accordance with an exemplary embodiment depicted in FIG. 49, it may be desirable to have a Recent Posts Web Part. The Recent Posts Web Part can be easily used to access the recent post. In one embodiment, the Recent Posts is a Web Part, alternatively the Recent Posts interface is an Object or a Feature that shows a list of unread recent posts.

The Recent Posts interface is useful when, for example, if a user has 500 friends, there are at least 100 recent posts by his friends or other users—such as family or friends of friends. In this scenario the user can click on this Recent Posts Drop Down List and see the unread posts by his friends or any other users under his profile. Alternatively the user can view any subscribed feed posts i.e. feeds from any website that the user is subscribed to. Thus, a user can know all of the posts that are unread and can be read and the user does not have to keep scrolling down all the way to read all the missing posts.

### Voice Messages

In accordance with another exemplary embodiment, Voice Messages, just like text messages which are available on most of the web applications or web sites, may be enabled within the Social Networking environment. The Social Networking System may have voice messages where a user can record audio and send it as a voice message to friends or family or even type text and send the text as a voice message.

### Enable Auto-Post for Events

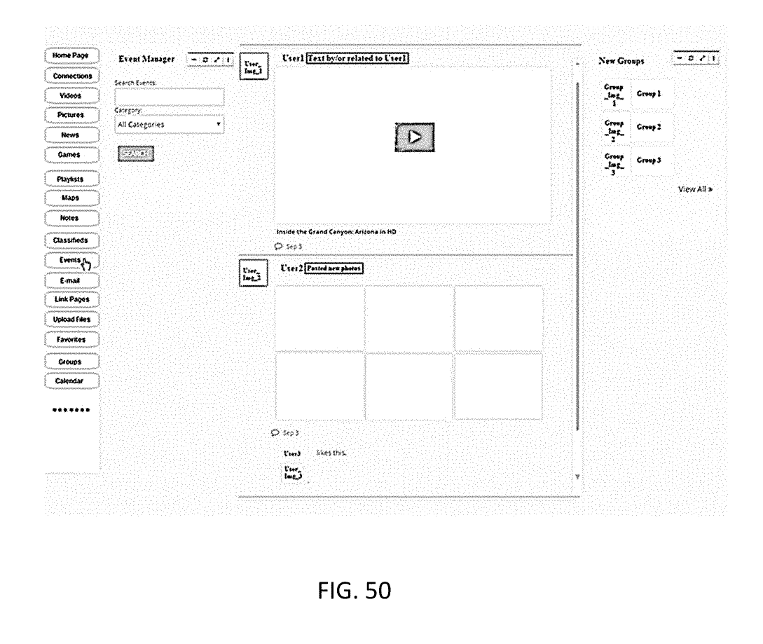

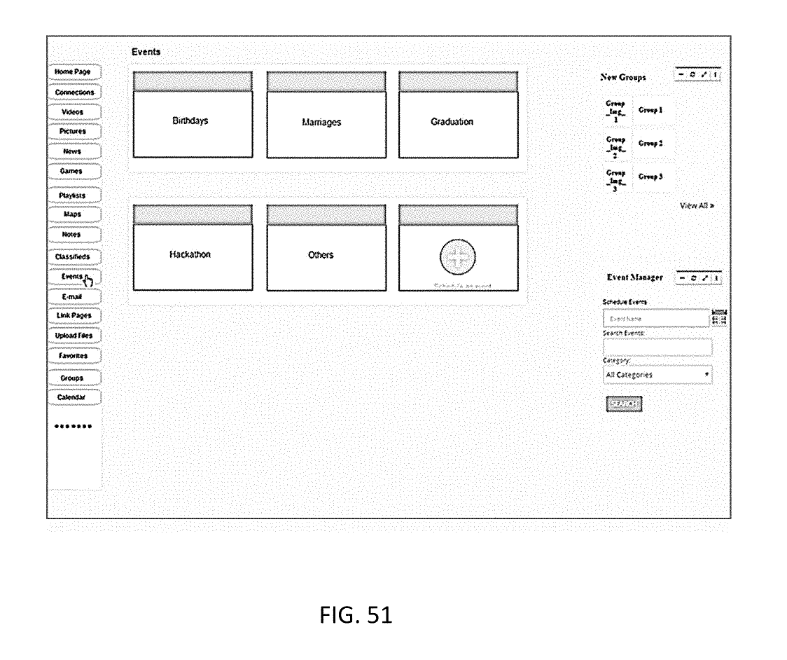

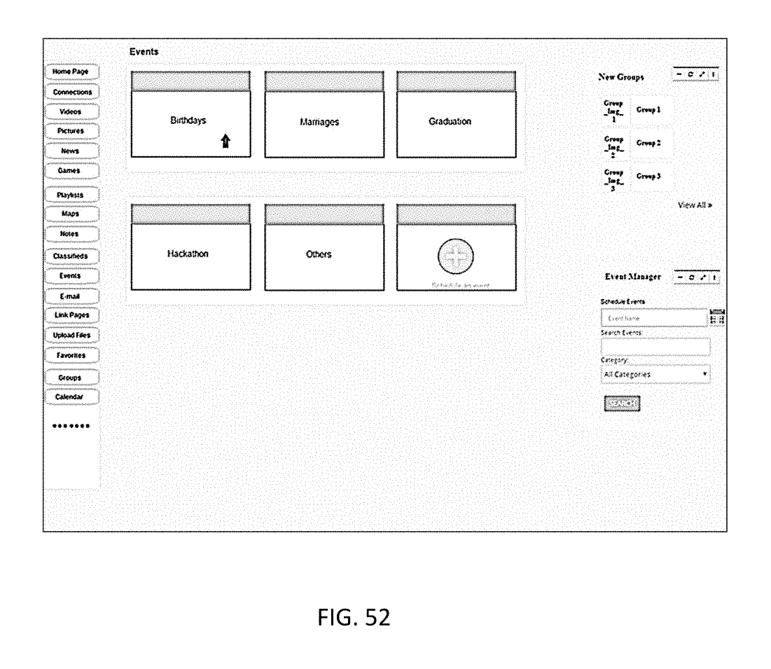

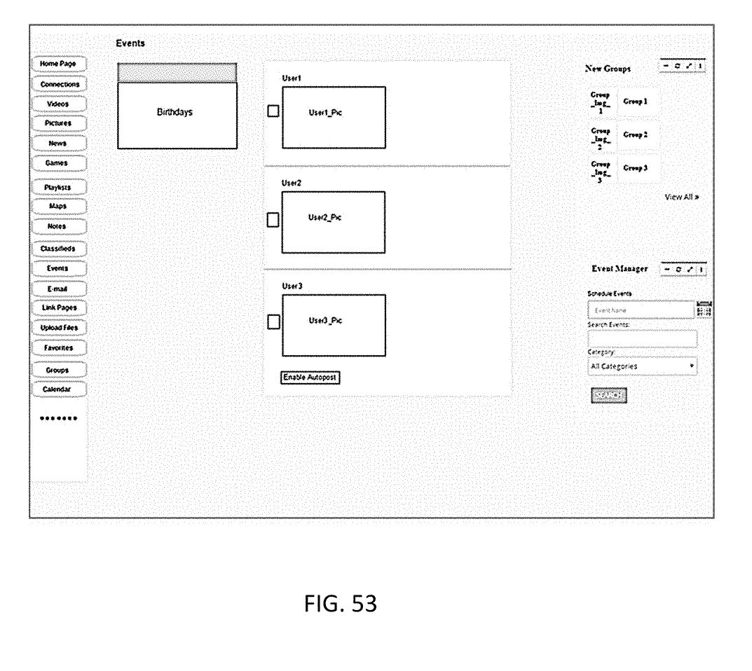

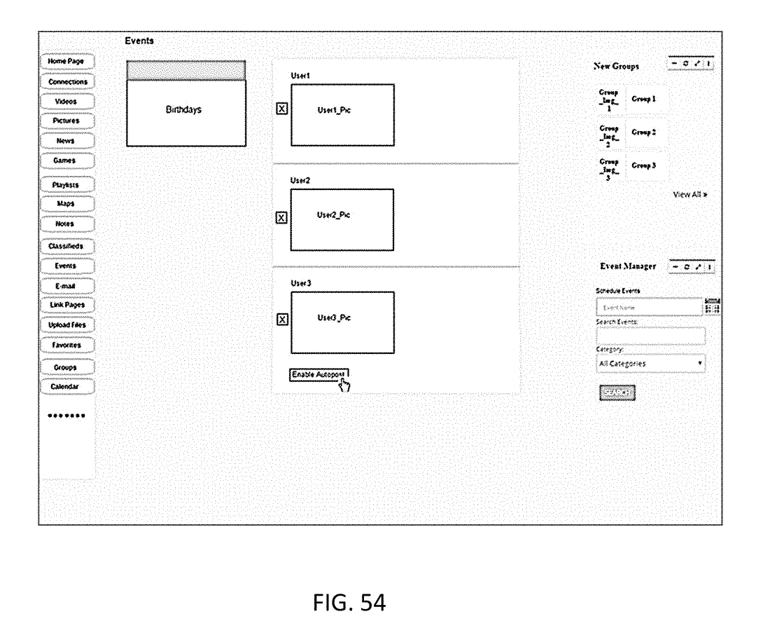

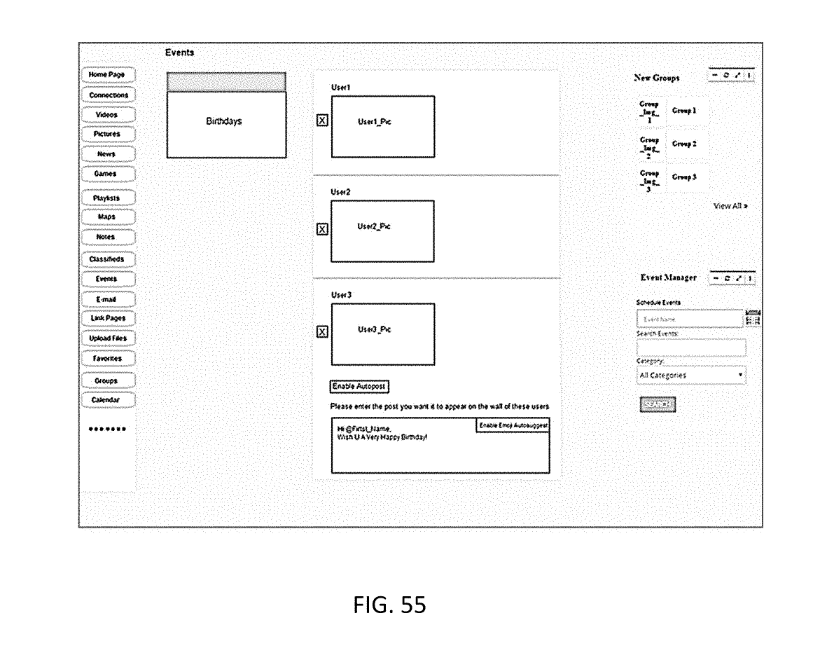

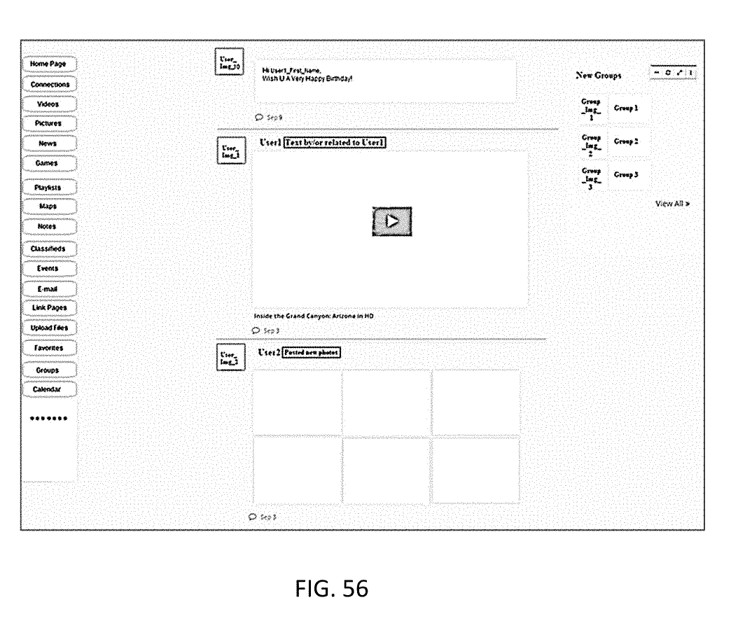

In yet another exemplary embodiment, a user may enable Auto-post for events in the User's profile within the Social Networking system. In the embodiment, the user can have a custom message for a certain event and the Social Networking system will be enabled to auto-post messages on behalf of the user to the selected events and to the selected users. The Auto-post for events functionality is depicted in FIGS. 50-56. For example, a user may select a Birthday event from the list of events and from the event can select a list of users. The user can type in a message to be posted to the other users on their birthdays, so that the user does not have to remember all the events (Birthday in this scenario) and may post an appropriate message (Wishing other Users under this User) automatically. When the user types in @First_Name, it uses the actual First Name of the User which the User has entered during signing up into the social Networking System.

### Autosuggest Emojis

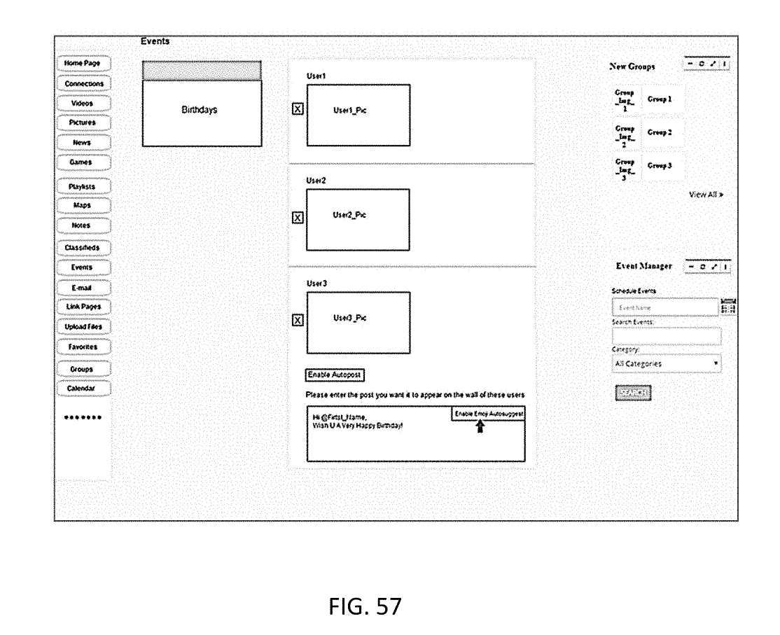

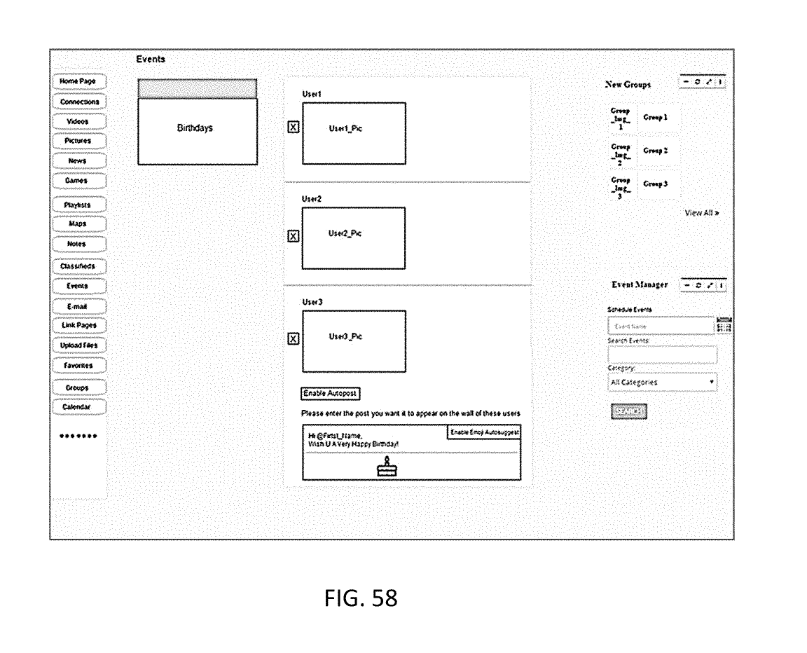

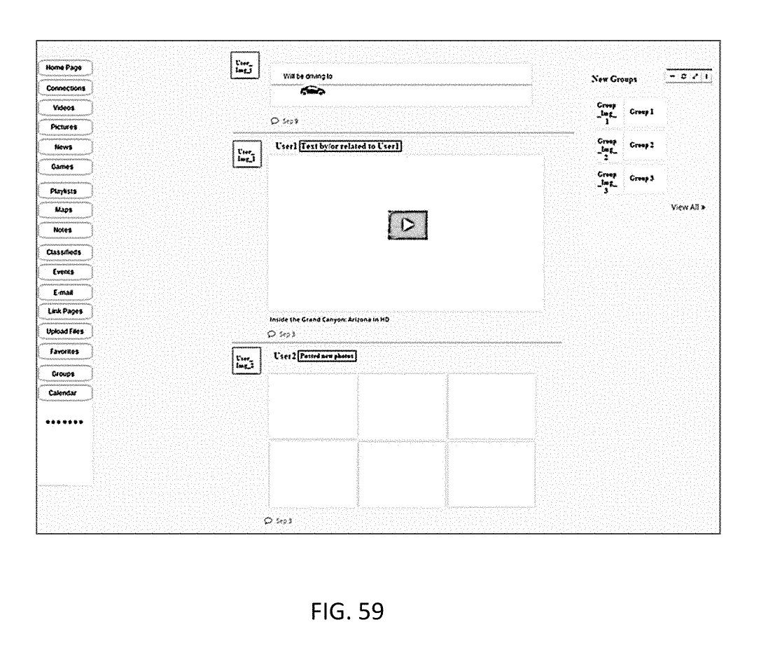

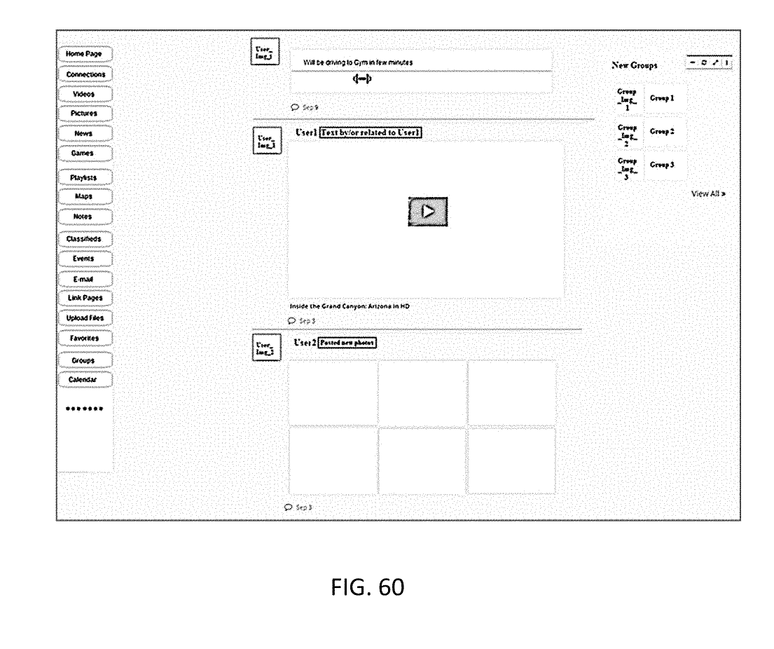

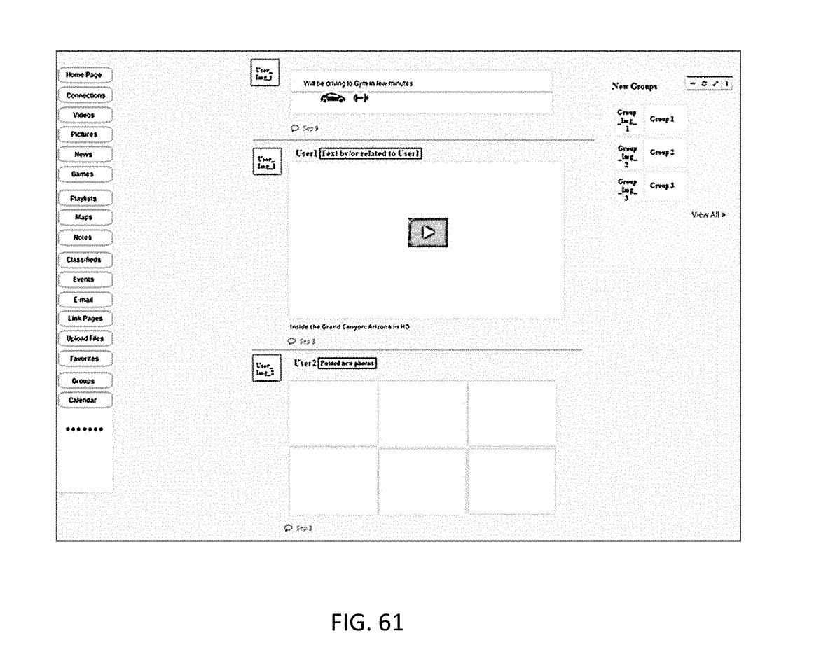

Referring now to FIGS. 57-61, an Autosuggest Emojis function is illustratively depicted. In accordance with an exemplary embodiment of the Autosuggest Emojis function, when a user types in a message across any pages under his profile in the social networking system/site, the user can enable the option of adding emojis to his text message. By choosing the Autosuggest emoji feature/option, as shown in FIG. 57, the user does not have to search for each emoji separately or look for the emoji symbols across hundreds or thousands of emoji symbols. Instead the user can type in the text as usual. The Autosuggest Emojis function would display the Emojis related to the text the user is typing and the user can select the emoji displayed below the text and include these emojis in the message.

### Sharing Current Activity/Status

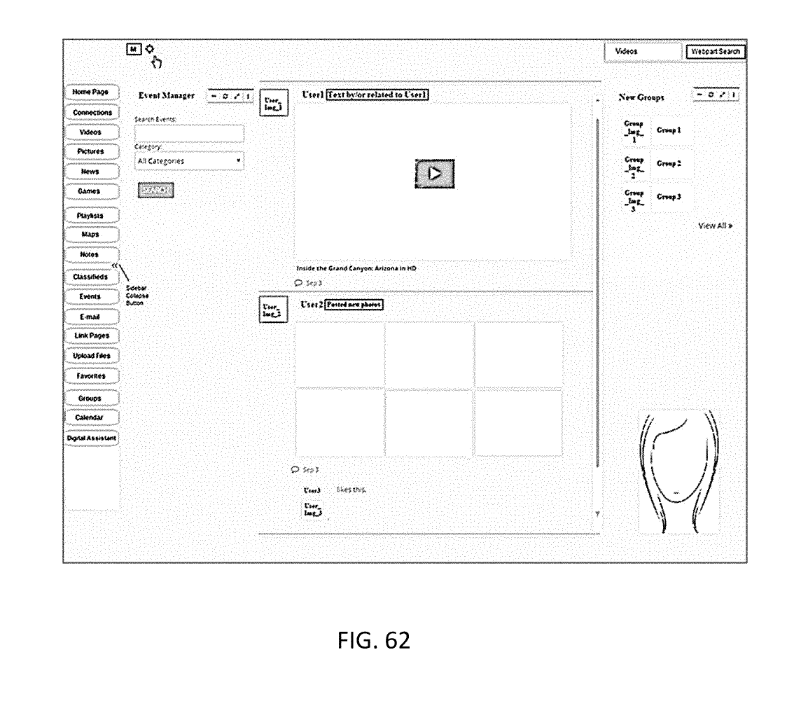

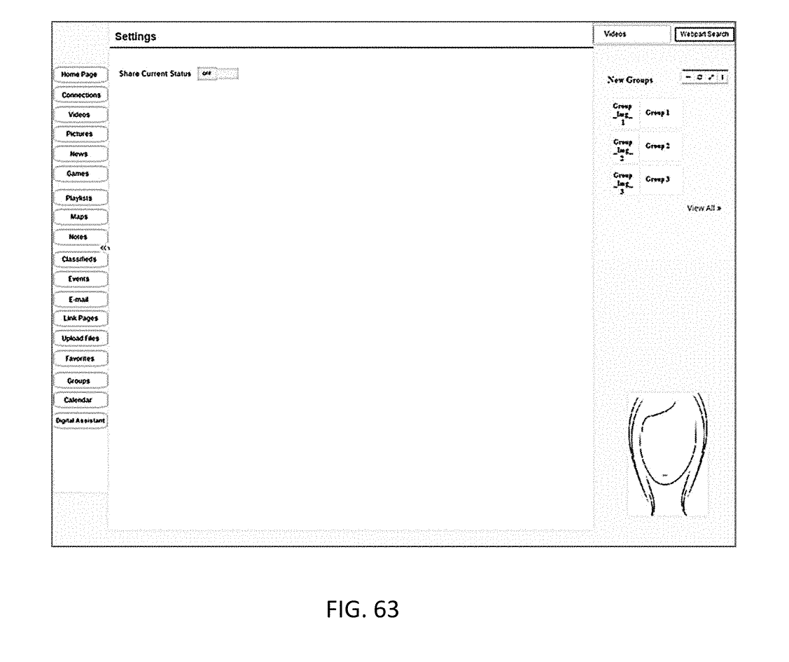

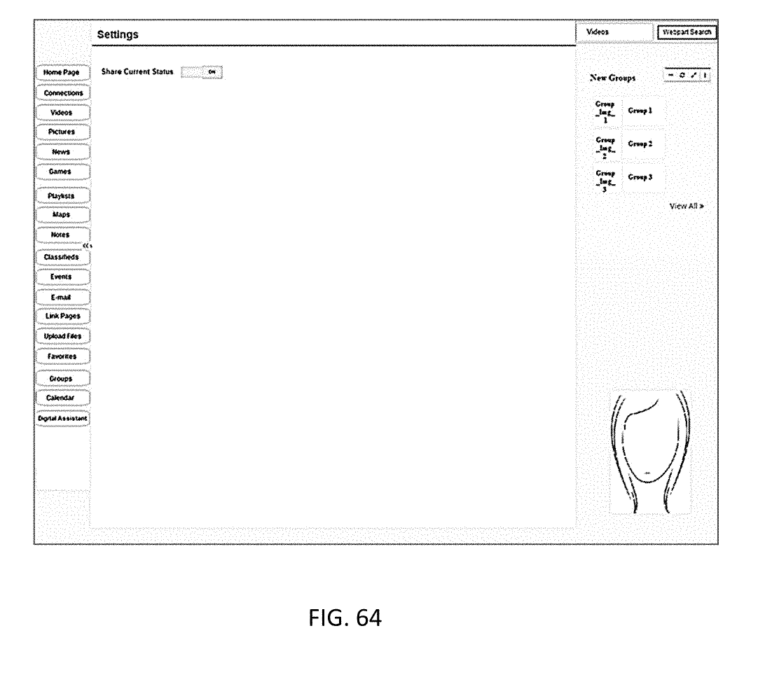

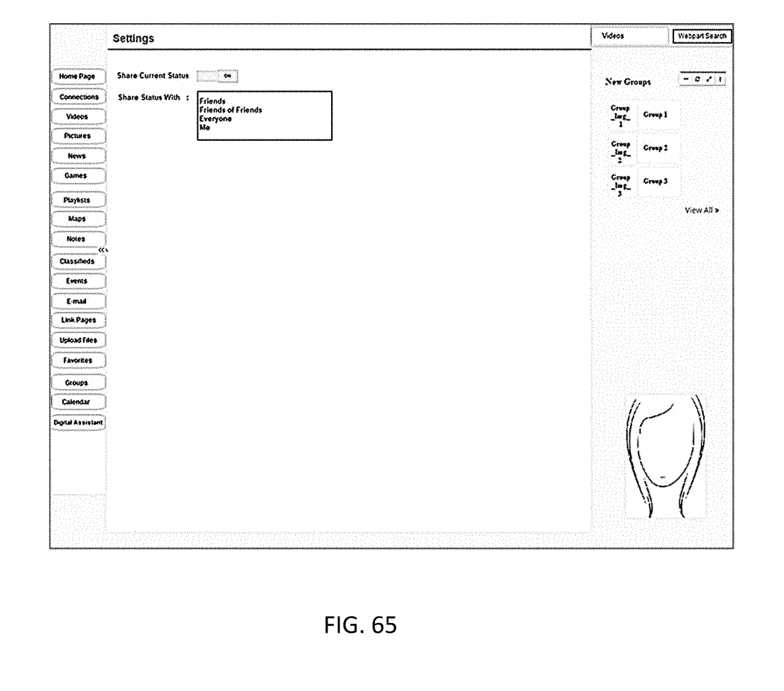

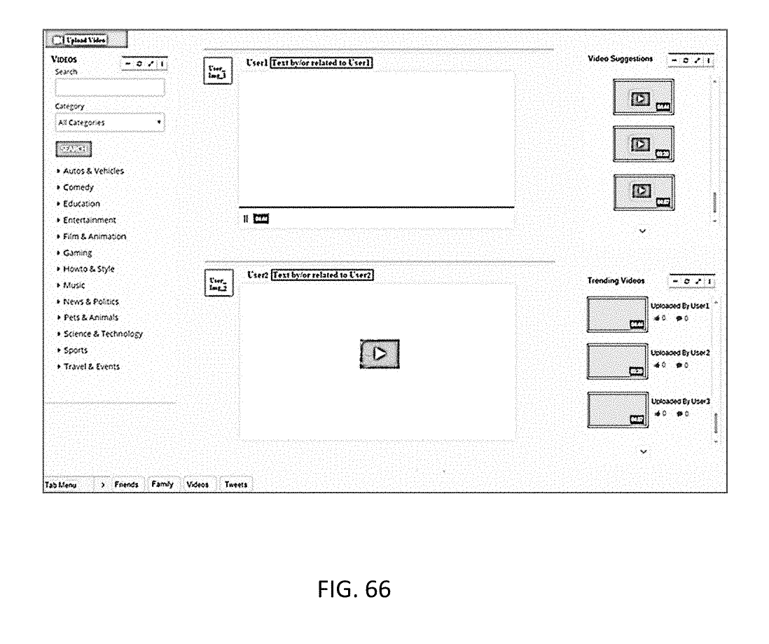

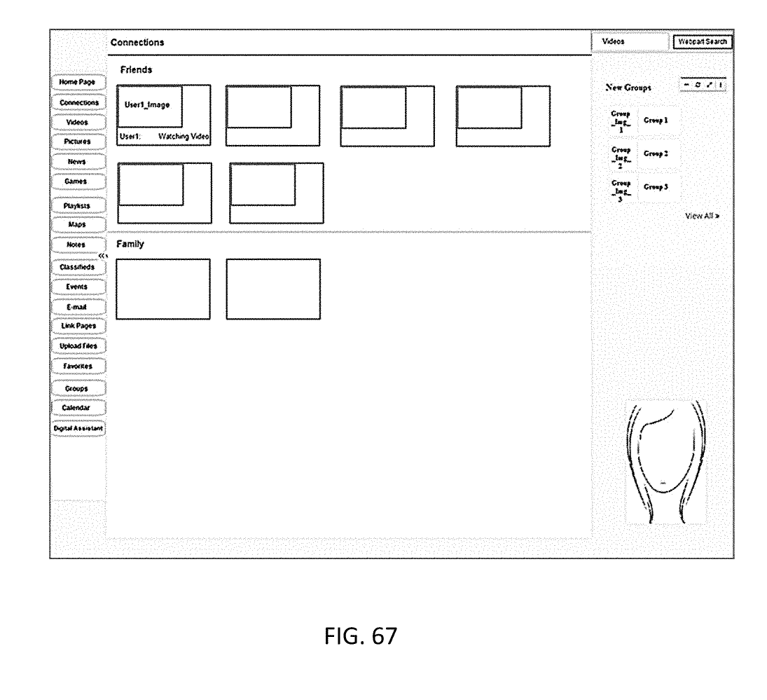

In accordance with yet another exemplary embodiment, when a user is watching a video or listening to music, for example, the user has an option to let his friends, family, friends of friends, or everyone, etc. know his Current Activity/Status Online. By changing the Settings in the social networking system, as depicted in FIGS. 62-64 to Share Current Status “ON” as opposed to “OFF”, the user enables sharing his status with others all over the social networking system. As depicted in FIG. 5, once set to “ON”, the user may select exactly whom they give permission to share with. In Accordance with an exemplary embodiment, as depicted in FIGS. 66 and 67, when the User is watching video, the other users who have this user under their network or connections can see the current activity or status of the user as Watching Video. Further, the user can let other users know even when he watched a video, so that the users with whom the User has shared his Activity or Status can know the User's status in the past 5 minutes such as User was Chatting with other User in the social networking system.

### Social Networking Block Diagram and Data Storage

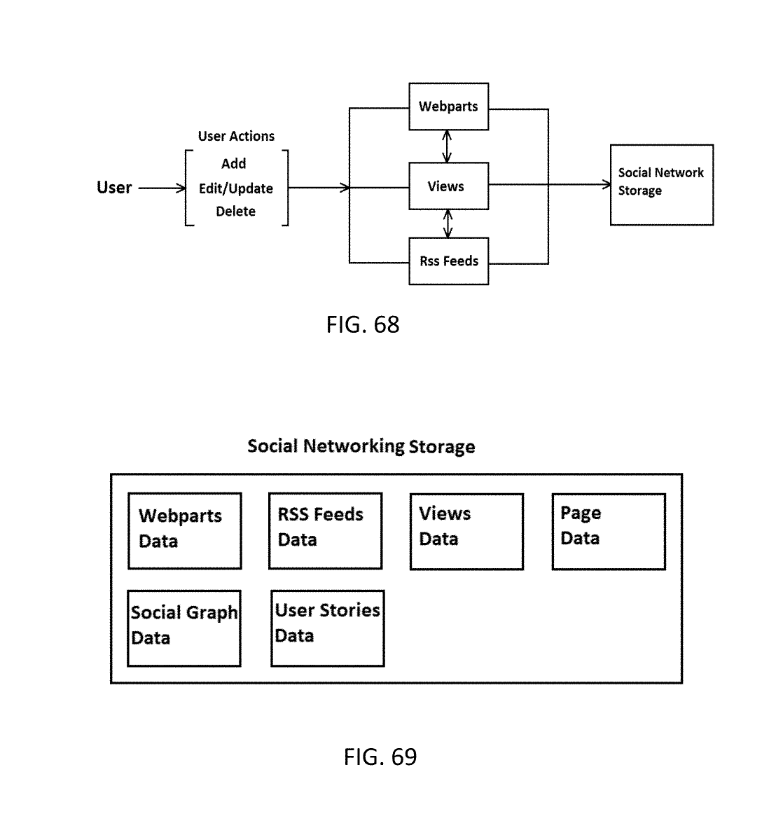

Referring now to FIG. 68, the exemplary block diagram shows the User Actions that a User can take on Web Parts, RSS Feeds or Views. The data pertaining to Web Parts is stored in Web Parts Data Storage module, the RSS Feeds Data Storage module stores the RSS feeds data and the Views Data is stored in Views Data Storage module. The changes made to the Pages in the Social Network under User's profile may be stored in Pages Data Storage module. The User Stories Data is stored in User Stories Data Storage module.

### Social Graph

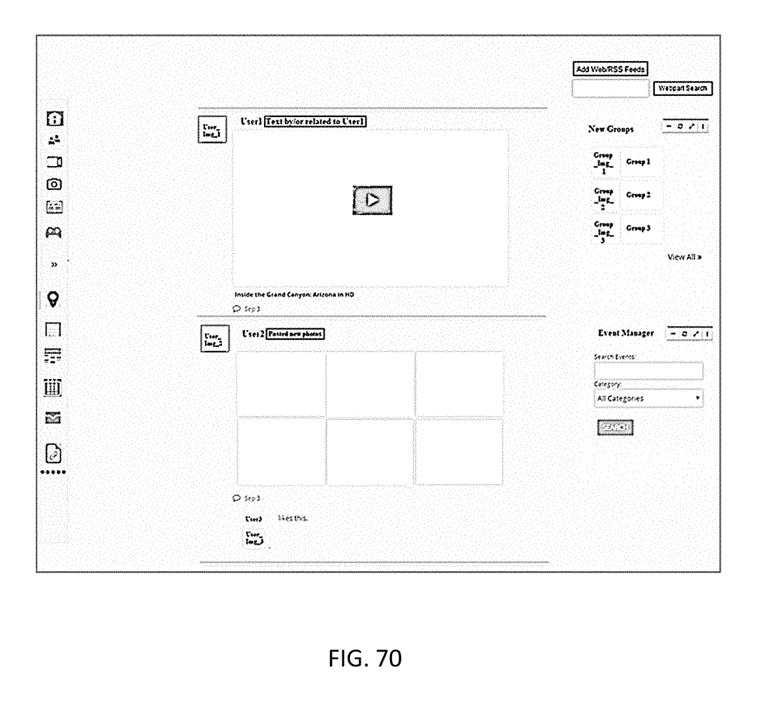

A Social Graph is a diagram that represents a network of nodes which are connected by edges. Each node may be a person or any object on the Social Network and the relationship between these nodes is represented by lines known as edges. Referring now to FIG. 69, a Social Graph Data Storage module may store the information of the social networking objects and relationship between those objects. For example, in one embodiment, the User Stories module may retrieve the user or any social network object data and parse it and match the parsed data with the data in the social graph (by checking the nodes and/or edges to read any related or similar user stories) and display the similar user stories to a user under the user story. Each of the Social Graph Data storage module may be related to a node of the Social Networking Graph.

### Web/RSS Feeds in Social Networking System:

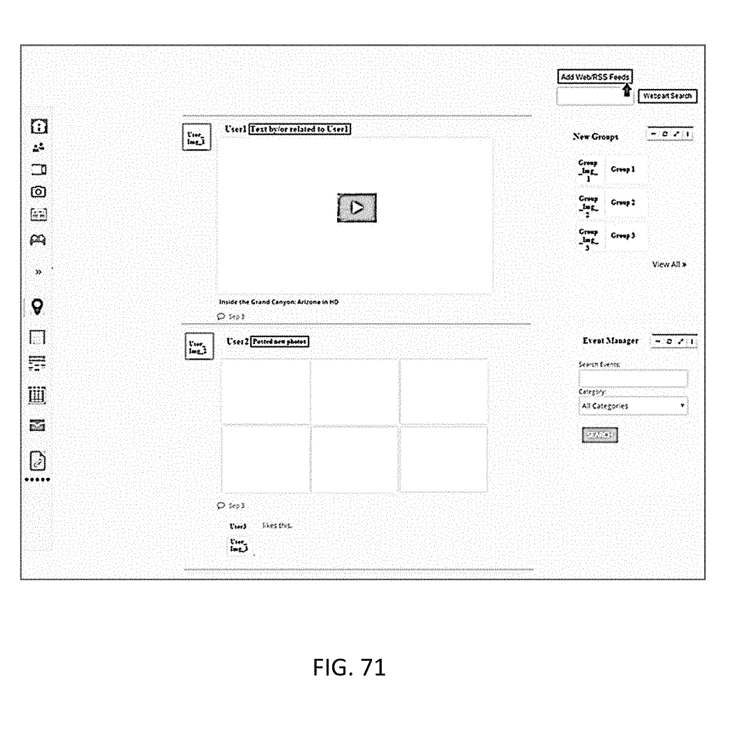

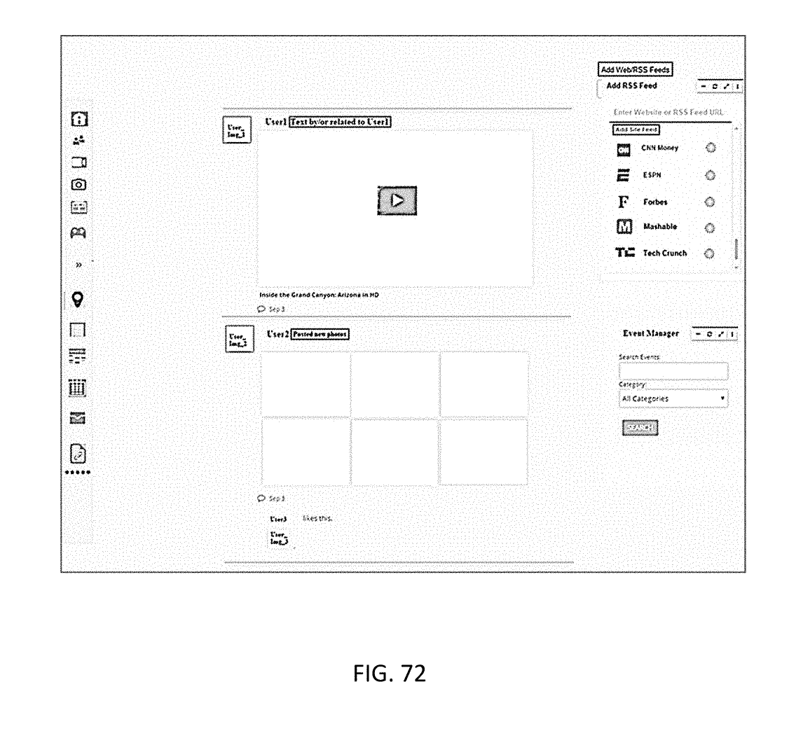

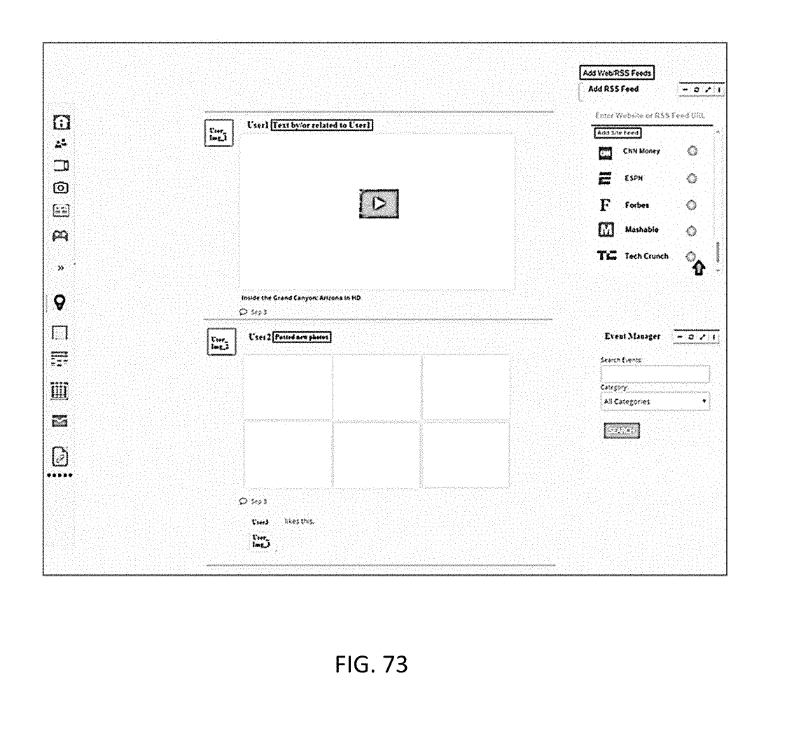

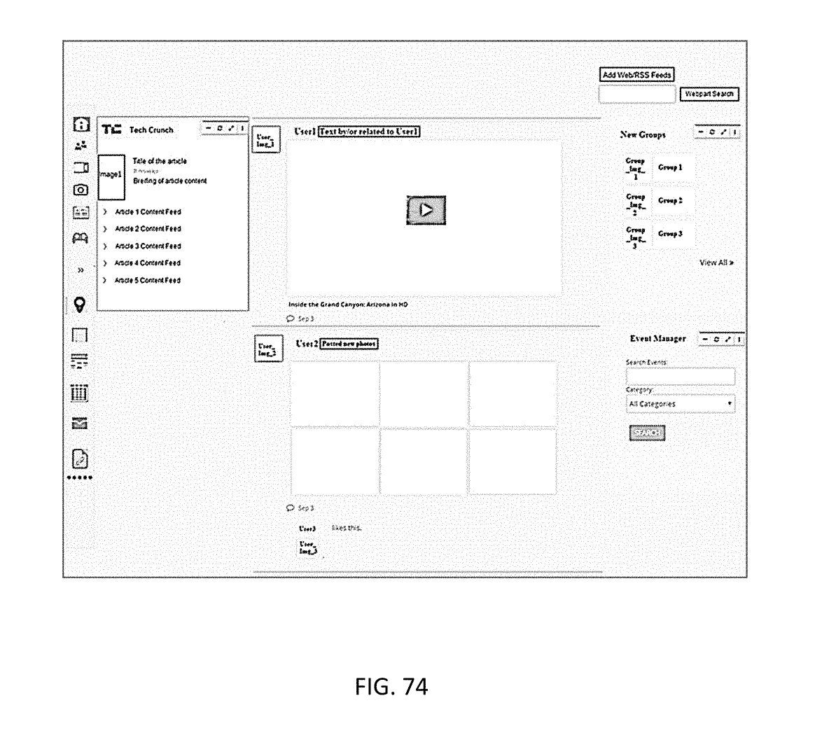

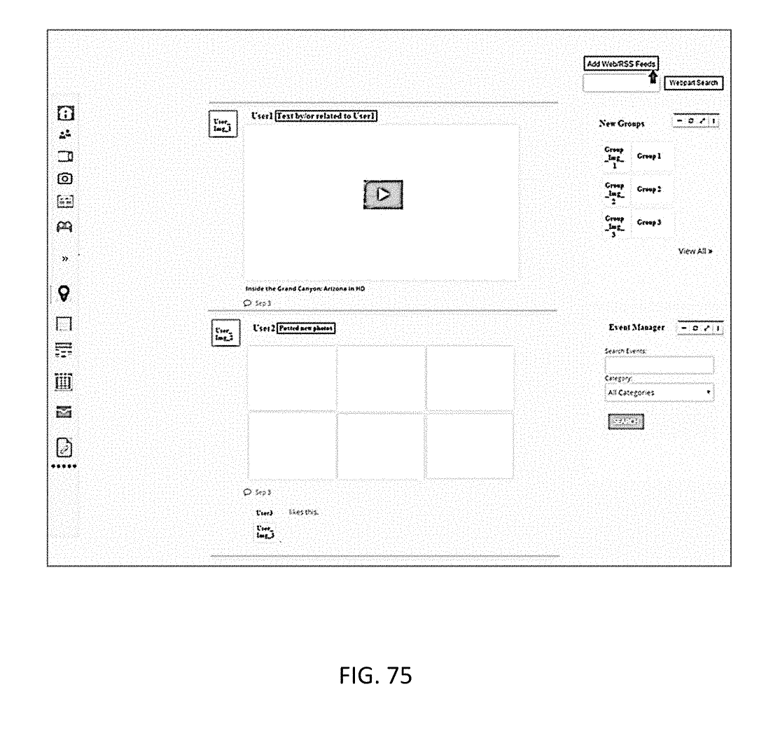

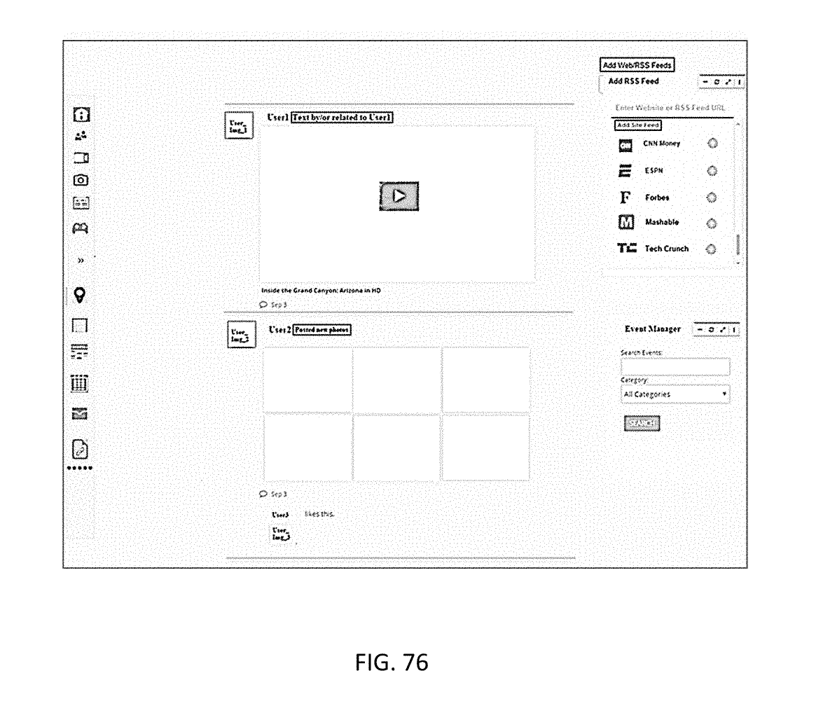

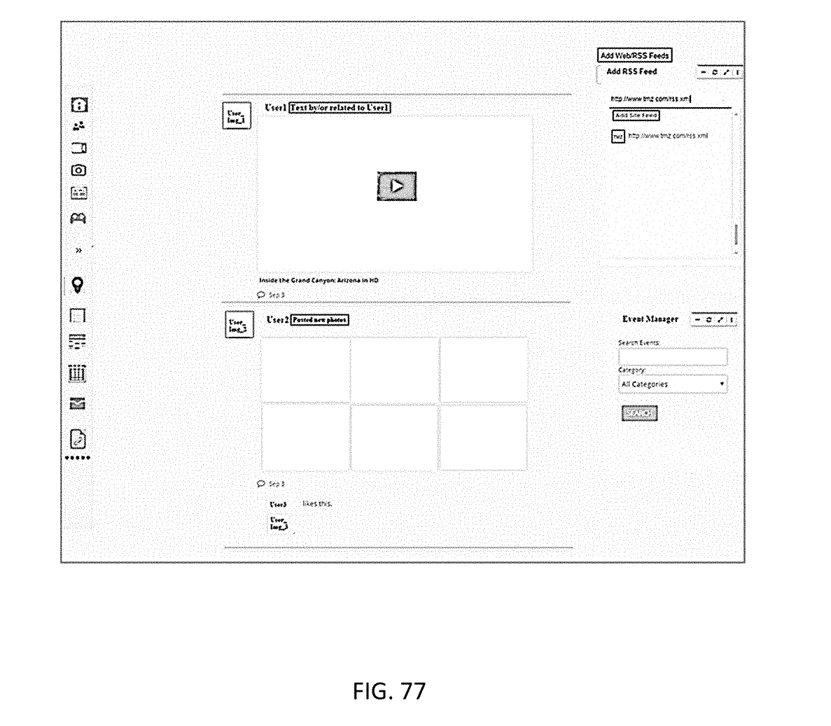

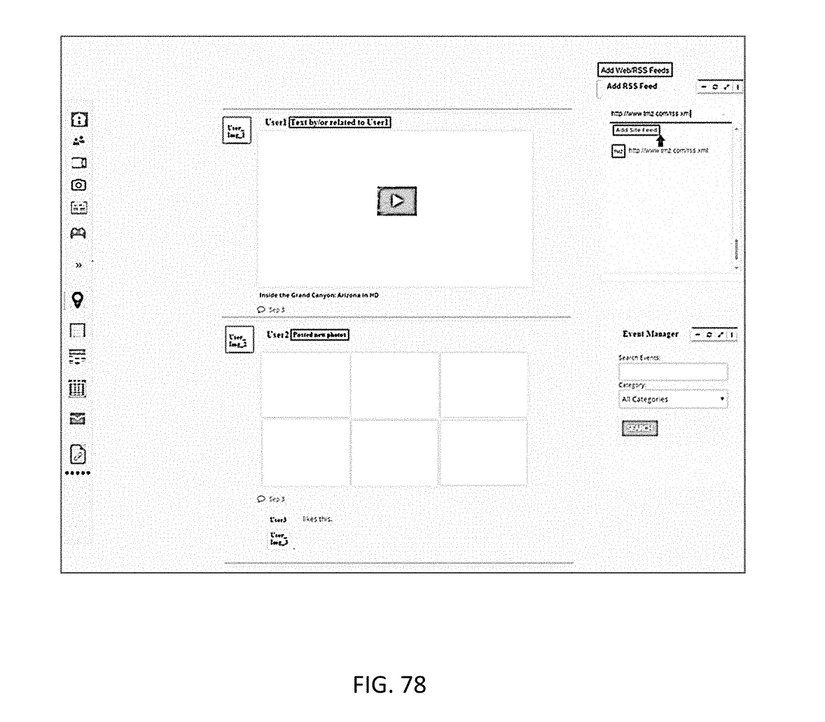

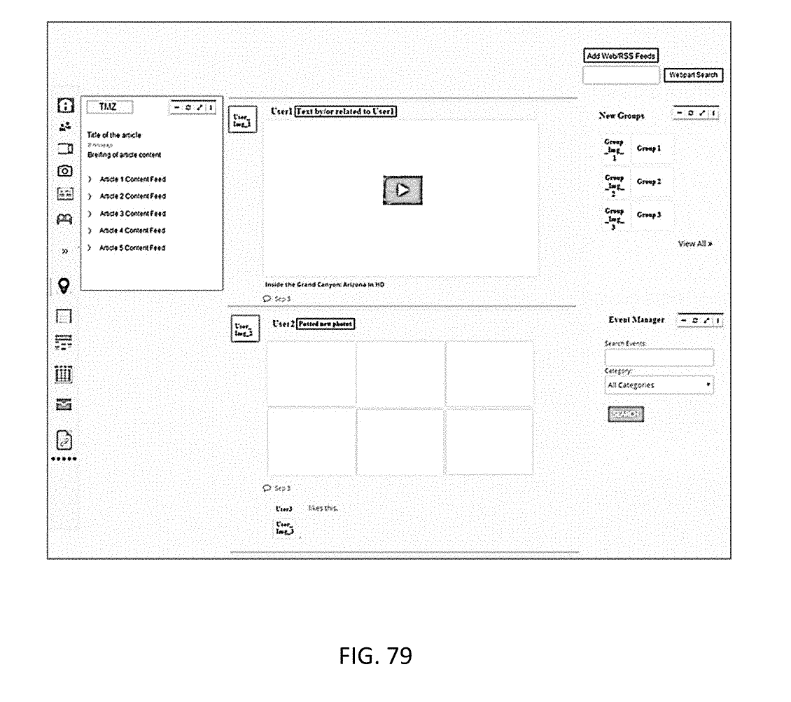

In accordance with another exemplary embodiment, Web/RSS feeds are other examples of Web Parts. Web/RSS Web Parts allow a user to get the latest feeds from third party websites and access them within their pages by adding them onto the GUI of the Social Networking system. As depicted in FIGS. 70-79 in a similar way that a User can search for videos (as depicted and discussed relative to FIGS. 5-11 for example), a User can search for Web or RSS Feeds available in the social networking system and may add them into the page similar to Web Parts. In accordance with an exemplary embodiment, using the RSS feed Web Part, a User may search for an RSS Feed by typing the URL of the website and adding to it to his page(s) in the social networking system. This optionality once again provides for increased efficiency for those who are regular users of the Social Networking site but who want to keep abreast of latest news and other feeds.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A Social Networking System, comprising:
a server capable of running a computer program product, the computer program product including a plurality of functional modules, including:
a Web Parts module configured to enable the use of Web Parts on a Graphical User Interface (GUI) for a particular user logged into their Social Networking Account;
an arrangement module configured to enable the adding, removing, placing, and moving of Web Parts on the GUI;
a view module configured to enable saving different views for a user, the different views including different arrangements and different collections of Web Parts; and
a digital assistant module configured to enable voice interfacing with the Social Networking System and allowing for voice interfacing to the various Web Parts on screen.

2. The Social Networking System of claim 1, wherein the Web Parts module enables overlay of Web Parts.

3. The Social Networking System of claim 1, wherein the Web Parts module enables overlay of Web Parts and enables the ability to cycle through overlaid Web Parts.

4. The Social Networking System of claim 1, wherein the view module enables a Video view, a Text view, and a Pictures View.

5. The Social Networking System of claim 1, wherein the view module enables a Video view, a Text view, a Pictures View, and a default view.

6. The Social Networking System of claim 1, wherein the arrangement module enables retrieving Web Parts from third-party sources.

7. The Social Networking System of claim 1, wherein the arrangement module enables searching for Web Parts.

8. The Social Networking System of claim 1, wherein the digital assistant module enables the use of natural language processing algorithms.

9. The Social Networking System of claim 1, wherein the view module enables the use of artificial intelligence algorithms for language processing.

10. A Social Networking System, comprising:
a server capable of running a computer program product, the computer program product including a plurality of functional modules, including:
a Web Parts module configured to enable the use of Web Parts on a Graphical User Interface (GUI) for a particular user logged into their Social Networking Account;
an arrangement module configured to enable the adding, removing, placing, and moving of Web Parts on the GUI;
a view module configured to enable saving different views for a user, the different views including different arrangements and different collections of Web Parts; and
a story boarding module configured to enable automated and semi-automated methodologies to capture events in a User's life story.

11. The Social Networking System of claim 10, further comprising: a digital assistant module configured to enable voice interfacing with the Social Networking System and allowing for voice interfacing to the various Web Parts on screen.

12. The Social Networking System of claim 10, further comprising: a live feed module configured to enable alerting of and providing live media feeds from selected sources.

13. The Social Networking System of claim 10, wherein the story boarding module includes a drawing generator module configured to interpret text and convert it to a related drawing.

14. The Social Networking System of claim 10, wherein the story boarding module allows a production of an illustrated story.

15. The Social Networking System of claim 10, wherein the story boarding module is configured to infer a User's activity based on a User's location.

16. The Social Networking System of claim 10, wherein the story boarding module is configured to enable a User to recall a series of events.

17. A Social Networking System, comprising:
a server capable of running a computer program product, the computer program product including a plurality of functional modules, including:
a Web Parts module configured to enable the use of Web Parts on a Graphical User Interface (GUI) for a particular user logged into their Social Networking Account;
an arrangement module configured to enable the adding, removing, placing, and moving of Web Parts on the GUI;
a view module configured to enable saving different views for a user, the different views including different arrangements and different collections of Web Parts; and
a live feed module configured to enable alerting of and providing live media feeds from selected sources.

18. The Social Networking System of claim 17, wherein the alerting includes at least one of a notification, a text message, a haptic signal, and an audio signal.

19. The Social Networking System of claim 17, wherein the live media feed includes an RSS feed.

20. The Social Networking System of claim 17, wherein the live media feed includes a video feed.
